(19) United States
(12) Patent Application Publication
(10) Pub. No.: US 2016/0150006 A1
(43) Pub. Date: May 26, 2016

(54) DEVICE DATA TRANSFER VIA A WIRELESS INTERFACE

(71) Applicants: AT&T Intellectual Property I, L.P., Atlanta, GA (US); Purdue Research Foundation, West Lafayette, IN (US)

(72) Inventors: Subhabrata Sen, New Providence, NJ (US); Vijay Gopalakrishnan, Edison, NJ (US); Oliver Spatscheck, Randolph, NJ (US); Seungjoon Lee, Basking Ridge, NJ (US); Sanjay Rao, West Lafayette, IN (US); Ashiwan Sivakumar, West Lafayette, IN (US); Shankaranarayanan Puzhavakath Narayanan, Lafayette, IN (US)

(21) Appl. No.: 14/550,742

(22) Filed: Nov. 21, 2014

(51) Int. Cl. H04L 29/08

(52) U.S. Cl. CPC H04L 67/1078; H04L 67/06; H04L 67/02; H04L 67/26

(57) ABSTRACT

Mobile device data transfer via a wireless network is disclosed. A data manager component (DMC) on a carrier-side of an air interface can receive a request for data from a device located on a client-side of the air interface. The DMC can collect data related to the data request. Data can be collected by the DMC from remotely located servers. The collected data can be parsed to facilitate determining additional data that can be collected based on the request for data. The collected data and additional data can be bundled and returned via the air interface to the device on the client-side. Bundling the collected data and additional data can be in accord with an IND scheme, an ONLD scheme, a PARCEL(X) scheme, etc. This can improve load times associate with the requested data and can also reduce power consumption associated with the data transfer over the air interface.

### GOVERNMENT LICENSE RIGHTS

This invention was made with government support under grant number 0953622 awarded by the National Science Foundation. The government has certain rights in the invention.

### TECHNICAL FIELD

The disclosed subject matter relates to wireless network communication, including mobile web interaction via a wireless network.

### BACKGROUND

By way of brief background, wireless communication can be encumbered with conventional protocols that may not provide an efficient data transfer scheme for communication with devices accessing data via a wireless network, e.g., over a wireless interface. The particular attributes of a wireless interface can be different from those of wired interfaces. These differences can cause application of data transfer schema developed for a wired interface to cause undesirable effects when applied in a wireless interface. Devices employing wired interfaces can be, for example, associated with lower latency, higher bandwidth, lower interference attributes, virtually unlimited power supplies, or different cost structures in contrast to devices accessing wireless interfaces. In a more particular example, a device, such as a desktop computer, connected to a wired interface, can have a nearly unlimited power supply and a very high speed network connection, and little attention can be paid to reducing power consumption or improving data transfers associated with sending or receiving data from the example desktop computer via the wired network, e.g., under a conventional data transfer scheme. In contrast, a mobile device, such as a tablet computer, can be operated on a battery having a notably more limited power supply and a slower wireless network connection, e.g., the wireless interface, than the desktop computer of the prior example. The example tablet computer can still employ a data transfer scheme similar to that used for the example wired network, except applied to a wireless network/interface. This can result in significant battery drain and slower data access wherein this example data transfer scheme does not embrace or consider the possibility of a limited power supply and wireless interface characteristics associated with mobile device and wireless network. As such, wireless networks/interfaces, especially those used with a mobile device, can benefit from improvements in a data transfer scheme that reflects the particular attributes of a wireless network/interface or the characteristics of a mobile device employing the wireless network/interface.

### BRIEF DESCRIPTION OF DRAWINGS

FIG. 1 is an illustration of a system that facilitates management of data transfer via a wireless interface in accordance with aspects of the subject disclosure.

FIG. 2 is a depiction of a system that facilitates management of data transfer via a wireless interface based on air interface information in accordance with aspects of the subject disclosure.

FIG. 3 illustrates a system that facilitates management of data transfer via a wireless interface comprising a radio access network component in accordance with aspects of the subject disclosure.

FIG. 4 illustrates a system that facilitates management of data transfer via a wireless interface comprising a profile adapted data manager component instance in accordance with aspects of the subject disclosure.

FIG. 5 illustrates example data bundling schema related to management of data transfer via a wireless interface in accordance with aspects of the subject disclosure.

FIG. 6 illustrates a method facilitating management of data transfer via a wireless interface in accordance with aspects of the subject disclosure.

FIG. 7 depicts a method facilitating management of data transfer via a wireless interface based on air interface information in accordance with aspects of the subject disclosure.

FIG. 8 illustrates a method facilitating receiving a data bundle related to management of data transfer via a wireless interface in accordance with aspects of the subject disclosure.

FIG. 9 depicts a schematic block diagram of a computing environment with which the disclosed subject matter can interact.

FIG. 10 illustrates a block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

Conventional management of data transfer via a wireless network/interface can act similar to techniques applied to wired network/interface data transfer. Conventional wireless network data transfer can largely ignore characteristics associated with devices employing wireless networks, e.g., mobile devices. The term air interface can refer to a communication link, e.g., a radio link, between a device and a base station, for example, between a mobile device or mobile base station and an active base station, e.g., a NodeB, eNodeB, etc. In an aspect, devices can access wireless networks via the ‘air interface’, or other ‘wireless interfaces’, and these two terms can be used interchangeably herein with the same or similar meaning, unless otherwise explicitly on inherently indicated. A wireless network can comprise at least one wireless interface and can otherwise further comprise either, or both, wired and wireless links. As examples, a cellular network, a Wi-Fi network, a Bluetooth network, etc., can be wireless networks that each comprise a wireless interface. Wireless interface characteristics, typically in contrast to wired interfaces, can include, for example, higher latency, lower bandwidth, higher interference attributes, generally limited energy resources, or cost structures that are different from non-mobile devices employing wired networks to access remotely stored data. Employing a data transfer scheme that reflects the characteristics of typical devices employing an air interface to access remotely stored data can provide benefits such as using less energy and therefore extending battery life, bundling of data prior to transmission over the air interface to improve data transfer rates, etc. While air interface friendly schema can provide benefit to nearly any device accessing remote data via an air interface, they can be particularly beneficial to mobile devices and, as such, for clarity and brevity, the following discussion is generally set in the context of mobile devices even though the disclosed subject matter is expressly not so limited. Furthermore, whereas air interface friendly schema can be applied to the access of nearly any type of data, in view of the ubiquity of accessing data via an air interface for web browsing, the following discussion can focus on mobile internet traffic for clarity and brevity of the disclosure, even though the disclosed subject matter is expressly not so limited.

Mobile web browsing can be viewed as an important activity on modern mobile devices and can account for significant cellular data traffic. Common mobile/cellular devices like smartphones and tablets transferring data via an air interface, e.g., a radio access network (RAN), can experience constraints that are different from fixed devices transferring data via a wired network. In an aspect, web pages can consist of numerous data objects spread over multiple server domains, and downloading pages in conventional technologies can involve a large number of HTTP request-response interactions in contrast to the presently disclosed subject matter that can allow, for example, a client browser to generate a single request for a webpage in the form of a URL to reduce the count of wireless transmissions over the air interface and/or improve energy consumption in gathering objects related to the URL, via the air interface and a backend component such as a DMC as disclosed in more detail herein, by the client browser. In another aspect, wireless networks can typically involve longer round-trip times than wired networks, often resulting in substantially longer download times for conventional technologies. These types of delays can be exacerbated where, for example, initial data objects fetched during a conventional download, e.g., HTML, cascading style sheets (CSS), Javascript (JS), etc., can require processing to identify other data objects to fetch subsequently, an aspect that can be accounted for by employing the herein disclosed subject matter, for example, a DCM as disclosed herein. Higher download latencies and frequent short data transfers, in turn, can leave a radio of a device in a high-power state, e.g., a state associated with transmitting or receiving data via a mobile device radio, for a longer duration that might be found for lower latency and less frequent but longer data transfer situations, which can result in further increased radio energy usage in conventional technologies, but which can be mitigated with the presently disclosed subject matter, such as a DMC, as disclosed herein.

The instant disclosure considers employing a device, e.g., a mobile device, on a first side of an air interface, or other wireless interface, and a device manager component (DMC) on the other side of the air interface, e.g., closer to higher speed or lower latency wired portions of a network commonly associated with a wireless carrier network core component. In an aspect, the DMC can be supplementary to the example mobile device in that it can assist in the mobile device data transfer in a way that considers the characteristics of a mobile device effecting a data transfer via an air interface. As such, the considerations can include determining, for example, a suitable division of web download functionality between the mobile device-side components and the wireless carrier-side components. This can improve user experience, e.g., quality of experience (QoE), etc., by improving data transfer times, e.g., reducing page download times, etc., or improving radio energy consumption over a user session, e.g., initial page download, subsequent user interactions with the page, etc. Where some studies have shown that, for example, the power consumed by a cellular radio interface can contribute a considerable fraction, e.g., ⅓ to ½, of the total device power during normal workload, the reduction in power consumption associated with employing a DMC can be particularly beneficial.

To this end, some embodiments of the disclosed subject matter can include a DMC that can perform object identification and download at the DMC, leveraging the generally superior network connectivity of a carrier-side network. In another embodiment, a DMC can support performing interactive operations locally at the client, e.g., the mobile device, to avoid network communication over the air interface to the extent possible. In some embodiments, a DMC can support wireless network friendly data transfers by reducing the number of interactions, e.g., HTTP request-response interactions, and by providing the DMC with the flexibility to push data objects, or bundles of data objects to the mobile device via the air interface, in a manner that is cognizant of latency and radio energy use. Additionally, some embodiments can apply optimization technology to communication of information between various components of the presently disclosed subject matter, e.g., to optimize the collection of data by the DCM, to optimize the transmission of a request for data, to optimize the return of data transmissions over a wireless interface, etc., for communication over a cellular network, without departing from the scope of the instant disclosure.

In accordance with an example embodiment of a DMC and a wireless network friendly scheme, both web-page latencies and radio energy consumption can be significantly reduced, perhaps by around 50% for web-page latencies and 65% for radio energy consumption compared to an example conventional web-browser operating without a DMC and employing a conventional wireless network data transfer scheme. In an aspect, unlike an example cloud-heavy browser, the example experimental implementation continues to perform well with user interaction at the experimental mobile device. Generally, these results indicate that some level of dividing functionality between a mobile device and a DMC can substantially enhance the user browsing experience, e.g., QoE, in cellular network settings.

Modern web-pages can be complex constructs that can, for example, comprise tens to hundreds of static and dynamic objects, e.g., banners, images, style-sheets, multiple and/or different types of JS files, etc., from multiple different domains frequently residing on more than one web server. As an example, an analysis of an example set of web pages indicates that, for example, 40% had at least 100 objects with at least 20 JS files. Further, the individual objects can often be small to moderately sized, e.g., from a few KBs to a few MBs. Across the example Alexa 500 pages, the 95th, 80th and 50th percentile of the object sizes were 386 KB, 107 KB, and 18 KB respectively.

Highlighting some of the problems in conventional mobile device data transfers that are particularly concerning in a wireless network, a conventional mobile browser, for example when downloading a webpage, can first initiate a DNS lookup to resolve the domain address for the main page URL, and can fetch the main page from the content web server using the HTTP protocol. It can then begin parsing the page and dynamically building and updating the Document Object Model (DOM) tree, an in-memory data structure to represent the objects in a html page. As the conventional mobile browser encounters new objects in the page that are not available locally on the mobile device, it can initiate a new HTTP request to a relevant server(s) for those objects. There can further be interdependencies among objects, e.g., downloaded JS files can be executed which, in turn, can lead to additional new objects, including more JS files, being downloaded. The resulting network traffic pattern can often consist of a large number of short data transfers, related to establishing distinct TCP connections per domain, resolving DNS lookups for the potentially large number of servers involved, and initiating a HTTP request/response associated with each object determined to be needed.

In an aspect, typical metrics used to quantify web page download latencies can include an “Onload event” that can be triggered by the browser when it has received sufficient objects for rendering an initial version of a page. The time from the request initiation to the time of the Onload event, can be referred to as Onload time (OLT) of the web page. OLT can be a commonly used Key Performance Indicator (KPI) for measuring the latency of the page load process and can indicate the initial responsiveness of the page. Objects can be requested by the page even after the OLT, and can occur, for example, due to the presence of asynchronous JS files, such as those used for displaying independent sections of a page, like advertisements and chat widgets, in parallel to the main web page. The time required to fetch all the objects required by the web page beyond OLT and in the absence of any user interaction can be termed Total Page Load Time (TLT).

In another aspect, in wireless networks, such as cellular networks, determining how application traffic interacts with Radio Resource Control (RRC) State Machine, such as for a 3G or LTE system, can be considered an important metric. A device can consume different levels of radio energy, often very different levels, in different RRC states. Generally, a device has to be in the highest energy state, e.g., a continuous reception (CR) mode, for data transfer to occur in a “connected state”. A lower energy state, e.g., a discontinuous reception (DRX) mode can enable the device to trade off some responsiveness for better energy savings which still remaining in a “connected state”. Different trade-offs can be selected, e.g., Short DRX, Long DRX, etc. DRX can actively poll for data transfers, typically periodically, and can turn off the radio at other times, thereby consuming less power compared to CR, but higher power than in an IDLE state, e.g., a “non-connected state”. An example mobile device radio can transition to IDLE from a CR or DRX state when no data has been received or sent for a determined time, such as sitting idle for >10 sec. The example mobile device radio can promote from IDLE or DRX to CR to send or receive data. Some research suggests that small data transfers on LTE can be very costly in terms of radio power consumption and that large data bursts can be much more energy efficient, even if it uses only a small fraction of the available network bandwidth, because the device doesn't loiter in CR and DRX modes as it would for the frequent small data transfers that can frustrate transitions to a prolonged IDLE mode.

Latency can also be an important characteristic to consider in wireless network transfers of mobile device data. Conventional web downloads on LTE networks can incur high latencies where typical RTTs for LTE can be high, e.g., of the order of 70 to 100 msec. A median OLT for a subset of an example set of 500 web-pages when downloaded using an LTE network can be, for example, >6 sec for 50% of the pages, with a maximum that can be about 13 sec. This can be in sharp contrast to a wired network with, for example, corresponding values of 1.1 sec and 4 sec. respectively. The latency can be further impacted where initial objects fetched during the download can result in determining other objects to fetch subsequently, dragging out OLT and/or TLT. The use of conventional web proxies can partially ameliorate the situation by resolving the DNS by the proxy. However, the conventional solution can still involve a large number of short data transfers due to request-response semantics, e.g., request-response flow of the HTTP protocol. Moreover, the conventional web download pattern of a large number of short data transfers over several seconds can force a device to stay in a CONNECTED state, e.g., CR or DRX, for an extended period of time, including frequently transitioning from IDLE or DRX to CR. This type of traffic pattern can consume significant energy due to the aforementioned the energy characteristics of the RRC state transitions.

Simply offloading processes to the cloud, e.g., in a cloud-heavy, thin-client approach, with the cloud performing most of the compute intensive tasks including parsing and rendering web pages, JS execution, etc., can potentially reduce CPU usage on a mobile device, and correspondingly device CPU energy consumption, however, typical real world web page design and cellular network characteristics can limit performance of these types of browsers. As an example, interactive user actions, e.g., mouse hover, button clicks, etc., with cloud-heavy browsers can incur higher latency and higher device radio energy consumption than traditional browsers. This can be due to conventional browsers executing JS associated with the event locally in contrast to typical cloud-heavy approaches the can require communicating these events back to the cloud, executing the JS on the cloud, and then transferring the results back to the client, consequently increasing total device energy consumption. In contrast to the conventional approach of blindly offloading processing to the cloud, the instant disclosure can determine some processes to be performed at a DMC and other processes to be performed on a mobile device, effectively splitting functionality between the cloud and the device.

Further, some conventional browsers can offer support for data transformation and/or compression in the cloud, with the primary focus typically being to reduce the amount of data downloaded. While this can be useful, these techniques generally do not address the root causes for high page load latencies, e.g., multiple RTTs associated with per-object data request-response semantics, etc. Further, these conventional techniques generally do not lower device energy requirements and, in some cases, can increase radio energy consumption because the time for compression and/or transformation can lead to the radio being in a high-energy state for a longer duration than would otherwise occur. That said, compression and/or transformation can be orthogonal to the instant disclosure and can be integrated with some or all embodiments disclosed herein.

In contrast to conventional mobile offload beyond web browsing, that can offload code of generic applications, e.g., compute intensive face recognition applications, to the cloud to reduce computation time and save device energy, the presently disclosed subject matter can address issues such as multiple round-trip data transfer times. Moreover, the instant subject matter is different in that data flows into mobile devices from remote servers, with cloud servers potentially on the data path from the server to the device, via the DMC and, as such, the instant disclosure does not rely solely on cloud application servers.

In an aspect, to improve user experience, e.g., QoE, by employing the currently disclosed subject matter, such as, when browsing the web via cellular network, it can be desirable to reduce page load time and decrease radio energy usage, thereby often extending use time by reducing total device energy consumption. In contrast to traditional browsers that can employ per-object http request/response interactions, an embodiment of the presently disclosed subject matter can seek to avoid data transfer request interaction, e.g., http request/response interactions with the browser for individual objects, etc. Given the high RTTs of wireless networks, such as cellular networks, limited, yet responsive and radio energy efficient, client interactions can be desirable. As previously asserted, cloud-heavy solutions that offload JS execution to a proxy in the cloud can entail additional network communication with the proxy to support the client interactions and can actually increase page load times and energy usage. As such, an embodiment of the instant subject matter can handle dynamic page changes and user interaction locally at the mobile device, e.g., at the client, to limit additional network communication. Further, radio-friendly and latency-sensitive data transfer can be employed to avoid radio state transitions. In an aspect, this can include bundling data being transferred to and/or from a mobile device via an air interface, e.g., a DMC can bundle data for transmission to the mobile device. In doing so, it can be important to take details of the webpage download process into account to reduce any impact on page latencies.

In an embodiment of the instant disclosure, data transfer functionality can be distributed between a device and a component of a wireless network, e.g., between a mobile device and a DMC associated with a wireless carrier network. Where the data transfer is, for example, associated with a traditional browser interaction, when a user enters or clicks a URL, a browser on the mobile device can generate a request for this URL via an air interface to the DMC, for example, the client browser can generate a single request for a webpage in the form of a URL sent to a DMC or similar component. In response to receiving the request, the DMC can perform DNS lookups and can request the URL from the corresponding web server(s). On receiving the response(s) from the web server(s), the DMC, rather than just forwarding them to the mobile device, can parse the response(s), e.g., a received example web page, to identify, by the DMC, objects that can be needed to successfully render the page on the mobile device. This can include, for example, parsing an HTML page to identify objects in that page, processing JS to determine dependencies or point to objects that are dynamically identified, etc. The DMC can then request these additional data objects without needing to involve the mobile device, reducing the associated additional communications over the air interface between the DMC and the mobile device. Further, the DMC can apply compression and/or transformations, e.g., transcoding images, shrinking size, etc., to objects collected by the DMC, before transmitting them to the mobile device over the air interface. Moreover, it will be expressly noted that both the client side device, e.g., mobile device, and the backend device, e.g., DMC, can execute programming scripts or programming components, e.g., JS, etc., associated with transferring data, e.g., data associated with a destination URL, for the same or different rationales, for example, the DMC can execute JS to ensure that relevant objects are collected while the client browser can execute the same JS to facilitate responsiveness for a user, etc.

The example mobile device browser, for its part, can receive the main HTML page and objects associated with the page from the DMC. It can then behave like a traditional browser, in that it can parses the HTML files and identify objects on that page. However, unlike traditional browsers, an additional request for these objects can be avoided because the objects are being proactively fetched by the DMC and transmitted to the mobile device as part of the example initial URL request. The mobile device browser can use the meta-data associated with the data collected by the DMC and transmitted via the air interface to the mobile device to identify the correct object and use it for rendering the example webpage. As part of this process, the mobile device can also parse CSS files and can processes JS. While there can appear to be repetition of work at the DMC and the mobile device, the example illustrates that the currently disclosed subject matter allows for the usual interactivity to be locally handled at the mobile device, e.g., by the example browser, and therefore allow the example webpage to feel responsive while still being energy efficient. That said, the currently disclosed subject matter does not preclude optimizations that can allow the client to leverage the work done by the DMC as part of a rendering process, e.g., such as using some of the JS processing done by the DMC at the mobile device.

The currently disclosed subject matter addresses some of the important issues with conventional mobile web browsing. In an aspect, by sending minimal data transfer requests, e.g., just the single URL request in the prior example, to a DMC, in some embodiments sending no other requests, the currently disclosed subject matter can reduce the number of round trips from the device to the DMC via an inherently high latency air interface link, thereby reducing page load times. In an embodiment, the DMC can be implemented on, for example, a powerful server with lots of processing power, high bandwidth, and low latency to the Internet. Consequently, having the example DMC identify which objects to download, e.g., through html parsing and JS processing, can allow for fast downloads of these objects to the DMC and subsequently to a mobile device over an air interface. Further, by getting the example browser to just send the URL, we can get the client to not continuously use up radio energy. Similarly, by getting the example DMC to push objects to the mobile device, we can give it the flexibility to bundle and schedule data object transfers to the mobile device efficiently and in a wireless network-friendly manner.

In another aspect, the currently disclosed subject matter can execute code at a client device, e.g., a mobile device, such as, JS executed on the mobile device, which can minimizes network communications during a client session and can allow for responsive, yet energy efficient, client interactions. Though conventional cloud-heavy approaches can, in certain circumstances, lower device CPU energy consumption, this can be outweighed by an increase in radio energy consumption due to increased client interactions. In contrast, embodiments of the currently disclosed subject matter can incur similar device CPU energy consumption as compared to conventional browsers in execution. Moreover, CPU energy consumption can potentially be lowered by allowing the client, e.g., mobile device, to leverage the work done by the DMC as part of a rendering process.

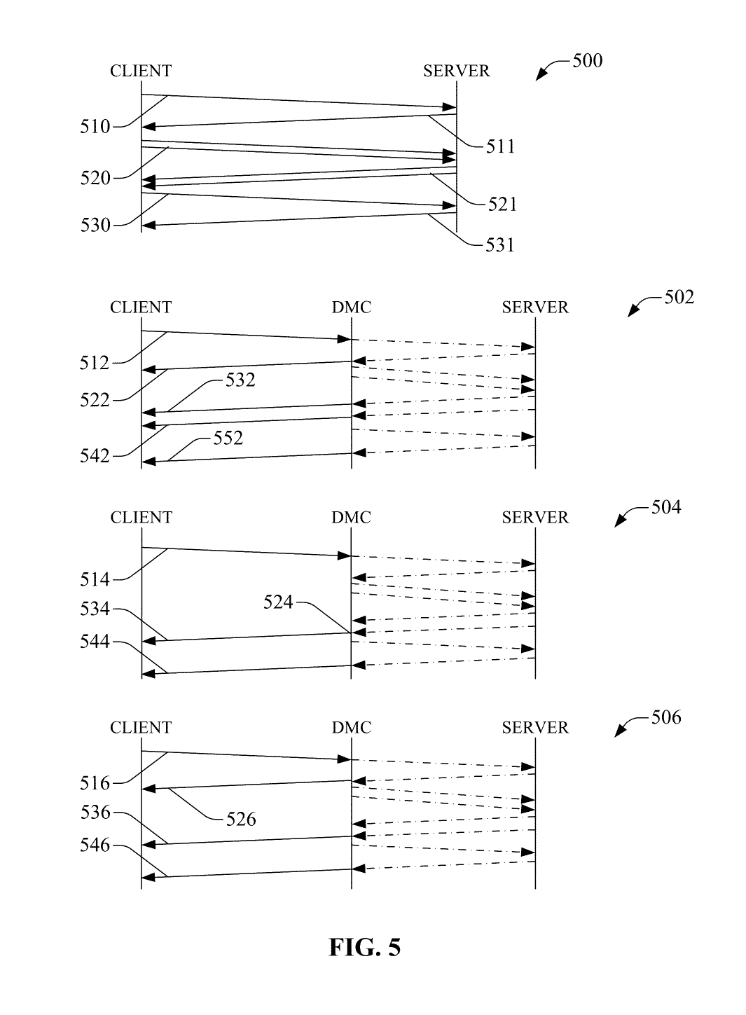

In a further aspect, once the DMC identifies and downloads the requested data, for example, the different objects on a requested webpage, it can have the flexibility of transferring the different objects to the client in a manner that is air interface friendly. Different air interface friendly schema can be employed, for example, as disclosed in more detail herein, a scheme called IND, a scheme called ONLD, and a scheme called PARCEL(X) can be air interface friendly schema. In the presently disclosed IND scheme, a DMC can transfer data objects to a client via the air interface, as and when the DMC receives the objects, see, for example, 502 of FIG. 5, etc. The IND scheme can reducing energy consumption and, further, can reduce OLT because it can relieve the client from making subsequent data requests and can allow the client to start processing HTML and JS objects as they arrive from the DMC via the air interface.

In the presently disclosed ONLD scheme, the DMC can fetch objects from a web server(s) and can transmit the data in a single bundle to the client, see, for example, 504 of FIG. 5, etc. The ONLD scheme can exchange increased OLT, as compared to the IND scheme, for further reductions in energy consumption because the client can go into an IDLE state while the DMC is downloading data and then can receive all the data as a single bundle from the DMC.

In the presently disclosed PARCEL(X) scheme, the DMC can select or determine a bundle size value that can be employed to strike a balance between the latency and energy benefits found in the IND scheme and the ONLD scheme. With PARCEL(X), the DMC can start transferring data to the client in data bundles of a certain size in relation to the bundle size value, see, for example, 506 of FIG. 5, etc. As such, PARCEL(X) does not need to wait for all data objects to arrive at the DMC, e.g., as can be found in instances of ONLD. Further, PARCEL(X) can buffer and bundle data objects to reduce the number, and increase the size, of data transfers via the air interface, in contrast to IND. PARCEL(X) can starts transferring data to the client when a certain threshold of data, e.g., “(X)”, becomes available or if the Onload event is detected. This can allows objects to transfer to the client from the DMC quickly while reducing the number of state transitions of the client radio. Further, other rules relating to determining the appropriate bundle size for PARCEL(X) can be employed, e.g., data bundle size less than a threshold value, greater than another value, is a multiple of a threshold value, is within a percentage of a threshold value, etc. Moreover, PARCEL(X) can employ other triggers and/or rules to initiate a data bundle push from the DMC to the client via the air interface, for example, an indication of a change in latency, a change in bandwidth, an increase in channel interference, etc., can all be employed to adapt the data bundle size or initiate/prevent an immediate data object bundle transfer.

In another aspect, the DMC can start parsing collected data, for example, a main HTML page, as soon as it is received and can identify data objects needed to render the collected data meaningfully, e.g., displaying an example webpage. As an example, if all the objects in a page are part of the received data set, the DMC can immediately start a rendering process. The client browser in this example, however, will not yet have the entire set of objects when it receives the HTML page under the IND scheme or PARCEL(X) scheme. Further, whereas some objects in the example can be requested after Onload, the object set under the ONLD scheme can also not have all the objects needed to render the example webpage. In some more rare cases, the use of JS can cause the object URL at the DMC to differ from the object URL at the client. In all these example cases, the client browser has to decide when to request the object because the missing object could already be on flight from the DMC. In an embodiment, the example browser can suppress making requests for missing objects. When the DMC determines that it has downloaded all the objects, it can send a notification to the client browser noticing completion. At that point, if there are still outstanding objects, the client browser can request the missing objects.

In a further aspect, in order to send the completion notification, the DMC can determine when it has completed the page download, traditionally indicated by the Onload event. For pages that request objects even after the Onload, the DMC can employ typical page statistics to make a determination of completion. As an example, an analysis of the Alexa top-500 webpages indicates that the inter-arrival time of objects is less than 5 sec for 95% of the objects after Onload. Based on this type of analysis, the DMC can implement a simple heuristic such that the DMC can wait for a determined period of inactivity between the DMC and data providing server(s) after Onload, and then can determine page completion. In the event that the DMC misses some object, the client can still request the missing objects.

In another aspect, code that downloads objects or renders data according to a characteristic of the rendering device, e.g., a webpage rendered differently for different browser implementations, can be accommodated by the DMC. The DMC can check for the type of access device, e.g., smartphone. laptop, tablet, desktop PC, etc., and can send objects tailored for the access device, e.g., different screen size, different operating system, etc. As an example, web servers can receive requests from the DMC rather than the browser, as such, the DMC can pass the relevant attributes about the client to the web server such that the corresponding objects are returned to the DMC and then pushed to the client. The client can send these attributes to the DMC, for example, when the client connects to the DMC and requests data, such as, clicking or sending a URL to the DMC. The DMC can then use this client information to emulate the client while downloading the data, e.g., from a remote data server.

In an aspect, the DMC and the client can both cache data. However, since the client does not request objects, other than the main URL via the DMC, the DMC can be unaware of objects that are cached at the client. Handling cookies and other session objects can be challenging for the same reason. In an embodiment, the DMC can track the object versions sent to the client, which can help avoid redundant transfer of objects. In another embodiment, a profile adapted DMC instance can be deployed as a personalized DMC instance for each client. In some embodiments, this can be accomplished by running the profile adapted DMC instance on a virtual machine. This can allow the proxy to mirror, at the profile adapted DMC instance, the state of the objects, including cache and cookies stored at the client. While the DMC can be located in public clouds, they can also be deployed similar to middle-boxes within the wireless carrier networks. Further, wireless carriers can deploy a DMC closer to the edge of the network and have a tighter coupling with the cellular RAN base stations to improve energy efficiency.

Handling encrypted data or pages can be accomplished by causing the DMC to fall back to the traditional way of downloading web pages since the DMC can have difficulty parsing and identify objects needed for such pages. However, using a profile adapted DMC instance where the user trusts the DMC can allow HTTPS requests to be properly handled by setting up independent secure channels between the client and the data server. The DMC can handle POST requests by relaying them to the data server as received from the client. If the POST response from the data server is HTML, the DMC can processes the response as previously explained before sending it to the client. For HTTP responses that do not have content, e.g., HTTP 204, the DMC can forwards this unmodified to the client.

An example analytical model can illustrate the trade-offs between the various data transfer schemes presented, e.g., IND, ONLD, and PARCEL(X). Suppose B is the aggregate object size at the time of page Onload event. Assume that n equal-sized bundles are used and that the DMC sends out the n^{th} bundle as soon as the Onload event occurs at the proxy. The IND scheme can be approximated as a case with large n. Further assume that the (n−1)^{th} bundle transfer was complete before the proxy Onload event. Define s(n) to be the download speed between a DMC and a client with n bundles. The OLT can be denoted at the DMC as Tₚ, which can be assumed independent of the number of bundles.

With regard to radio energy, it can be assumed, at the time of a client Onload event, that after each bundle transfer, the client completes CRₜₐᵢₗ and SDRX cycles. The duration of each cycle can be denoted d_{c} and dₛ. The aggregate duration of LDRX cycle dₗ(n) before the n^{th} bundle arrives at the client can be:

$${d}_{l} ( n ) = {T}_{p} ( n ) - \frac{( n - 1 )}{n} \frac{B}{s ( n )} - ( n - 1 ) ( {d}_{c} + {d}_{s} ) .$$

This can be determined from accounting for the transmission and state transition time for (n−1) bundles before the transmission of the n^{th} bundle. Then, the radio energy for LDRX, state transition, and actual transmission can be determined to obtain the total radio energy at the time of client Onload as:

$$E ( n ) = {p}_{l} {d}_{l} ( n ) + ( n - 1 ) ( {p}_{c} {d}_{c} + {p}_{s} {d}_{s} ) + {p}_{c} \frac{B}{s ( n )} ,$$

where pₗ, p_{c}, and pₛ are power consumption in LDRX, CR, and SDRX states, respectively.

For ease of exposition, assume that s(n)=s for all n and that E(n) is a continuous and differentiable function of n². By solving E′⁽ⁿ⁾=0, an optimal bundle count, n*, can be determined that minimizes radio energy:

$${n}^{*} = \frac{1}{α} \sqrt{\frac{B}{s}} ,$$

where α={square root over (((p_{c}−pₗ)d_{c}+(Pₛ−pₗ)dₛ)/pₗ)}. Then, it follows that the optimal bundle size b* is:

$${b}^{*} = \frac{B}{{n}^{*}} = α \sqrt{s B} .$$

For higher download speeds, larger bundles are more acceptable since there is less penalty in waiting longer. Further, as web pages become larger, using larger bundle sizes ensures the total number of bundles, and the associated state transition overhead is limited. Lastly, α captures relative radio state transition overhead due to radio technology and parameter settings, that is, as transition overhead increases, it becomes important to use fewer bundles and reduce the state transition overheads.

To examine the tradeoff between energy and time, accounting for the transmission time of the n^{th} bundle after Onload at the DMC:

$$O L T ( n ) = {T}_{p} + \frac{1}{n} \frac{B}{s ( n )} .$$

Assuming s(n)=s, ∀n, OLT(n) is a decreasing function of n, which agrees with the intuition that OLT is likely better with smaller bundles. On the other hand, performance in radio energy depends on various webpage and network characteristics, as previously asserted. For example, for a 2 MB page, with download speed of 6 Mbps, and α=0.74, as derived from LTE parameter values, the optimal bundle size can be approximately 0.9 MB.

Some experimental results of example embodiments indicate that, overall, adding a DMC reduces both the incurred latency and the radio energy consumption when compared to traditional browsers by minimizing the HTTP request-response interactions and delegating the download process to the DMC. Execution of JS at the client to ensure responsive and energy efficient client interactions also proved functional and the cumulative total energy consumption with a DMC and client side JS execution in experiments performed resulted in lower energy consumption than a traditional browser at every point in the session. Experimentation also supported, as expected, larger bundle sizes increase the client OLT compared to IND. The energy results however are more nuanced, for instance, smaller bundle sizes, e.g., 512 KB, appear to give more benefit than larger bundle sizes. The typical large webpage ranges anywhere between, for example, 2 MB and 4 MB, and it was observed that download speeds ranging from 4 to 8 Mbps with median of 6 Mbps were attained. The optimal bundle size in the experiments was around 1 MB for those large web pages. However, energy saving in practice is largest with a bundle size slightly smaller than the optimal size as determined from the earlier equations (e.g., 512K instead of 1M). This can be due in part to some of the assumptions made, e.g., full state transition per bundle transfer, fractional n, etc. In practice, the observed download speed can be variable and hence larger bundles can be more severely affected by sudden radio signal degradation.

In embodiments of the currently disclosed subject matter, judiciously refactoring functionality between mobile devices and a DMC can significantly reduce page load times and radio energy usage in wireless networks. This is distinct from traditional browsers, in that the subject disclosure moves the task of identifying and downloading objects, for example, objects needed to render a webpage, to a well-provisioned DMC component. This is also distinct from existing cloud-heavy browsers, in that the subject disclosure retains most other functionality including execution of JS in the client browser. Generally, compared to a traditional mobile web-browser, the subject disclosure can reduce OLT by about 50% and reduce radio energy consumption by around 65%.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages and novel features of the disclosed subject matter will become apparent from the following detailed description when considered in conjunction with the provided drawings.

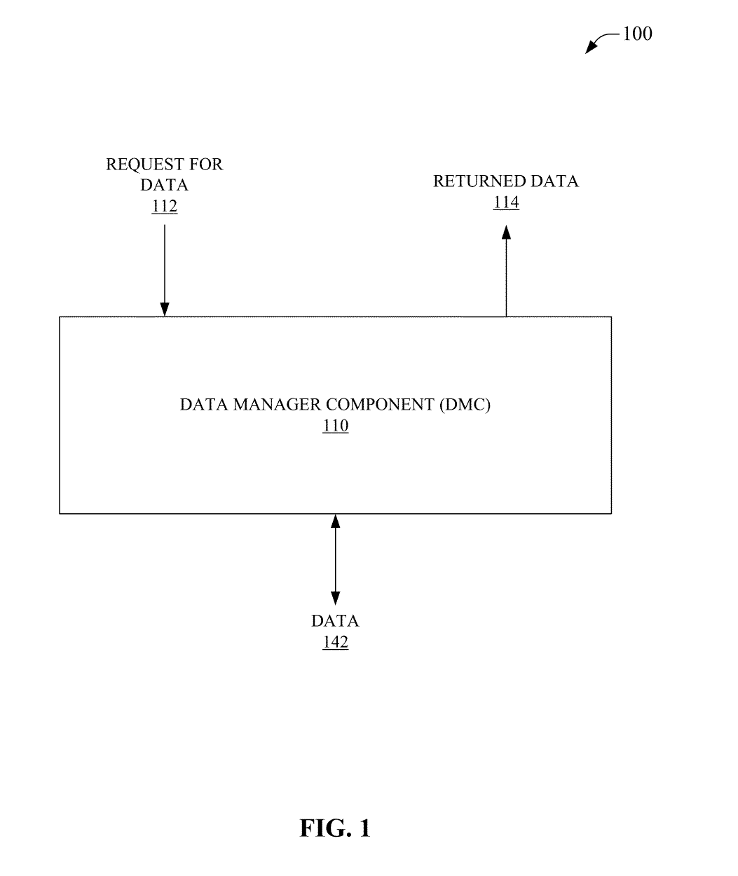

FIG. 1 is an illustration of a system 100, which facilitates management of data transfer via a wireless interface in accordance with aspects of the subject disclosure. System 100 can include data management component (DMC) 110 that can receive request for data 112 and facilitate access to requested data 114. DMC 110 can collect data 142. The collection of data 142 by DMC 110 can be in response to receiving request for data 112. Request for data 112 can be a request for nearly any type of data stored remote from a device associated with generating request for data 112. As an example, request for data 112 can be a request for scheduling data, sensor data, demographic data, word processing data, webpage data, etc. DMC 110 can receive request for data 112 and can act to gather the requested data. Gathering the requested data can include determining or resolving one or more data storage locations associated with the storage of said data. As an example, a request for data related to demographic information associated with an election of government representatives can be determined to be related to data stored on a government server, a social media corporation server, and a private think tank sever. DMC 110 can then collect the requested data, e.g., data 142, from the determined or resolved data sources. DMC 110 can then return data 142 as returned data 114. Returned data 114 can be the same or different from data 142, e.g., data 142 can be transformed, modified, supplemented, altered, compiled or aggregated, filtered, sorted, bundled, or otherwise altered as part of returning returned data 114. As an example, request for data 112 can comprise a URL for a webpage such that DMC 110 resolves the location of objects related to the URL and collects said objects, e.g., data 142, before returning a bundle of said objects as returned data 114 which can enable a device receiving returned data 114 to, at least in part, display the webpage associated with the URL of the request for data 112.

DMC 110 can be located on the opposite side of an air interface from a device associated with generating request for data 112. As an example, a device, not illustrated, can be a mobile device that can send request for data 112, via an air interface, which can be received by DMC 110 on the other side of the air interface. As an illustration of this example, DMC 110 can reside at a radio access network (RAN) device such that radio transmissions comprising request for data 112 from a smartphone device can be communicated to DMC 110 via the air interface enabled by the RAN device. As such, DMC 110 can be generally associated with lower latency, higher bandwidth, and lower interference conditions for network connections that that associated with a device on the other side of the air interface, e.g., the client side of the air interface. This is generally due to the air interface itself being slower, more constricted, and subject to interferers, in contrast to a carrier-side network, often a wired network, where DMC 110 can generally be located. Comparing access to data 142 for DMC 110 against direct access by a device on the client-side of an air interface, DMC 110 can be generally expected to be able to gather the data more quickly, at a higher rate, and with less data corruption than the client-side device would be able to achieve over the air interface. In an aspect, DMC 110 can serve as a buffer, of sorts, for the collected data, e.g., collecting it faster than the client-side device could over the air interface and then returning collected data as returned data 142 to the client-side device in a manner that conforms to the particular nature of the air interface. This can function to push returned data 142 at a rate that can improve energy consumption of the client-side device in contrast to accessing data 142 in the absence of DMC 110, and can also improve the speed at which returned data 142 is received by the client-side device in contrast to access data 142 without DMC 110.

DMC 110 can pass data 142 back to a device associated with request for data 112 as returned data 114. Returned data 114 can be subject to air interface friendly schema that can comprise the IND scheme, the ONLD scheme, and the PARCEL(X) scheme, etc. The IND scheme can transmit returned data 114 as and when data 142 is collected, e.g., with no functional buffering data 142 is simply passed back as returned data 114. Whereas DMC 110 is typically expected to collect data 142 faster than a requesting device could over an air interface without DMC 110, returned data 114 can be expected to be returned at a relatively faster rate than a requesting device could collect data absent DMC 110. Further, the IND scheme can also allow DMC 110 to parse data 142 as it is collected so as to determine additional data that can be collected as related to request for data 112. As an example, where data 142 is related to a webpage having javascript (JS), DMC 110 can emulate the execution of the JS to determine additional object that should be collected and then supplied to the requesting device via returned data 114.

The ONLD scheme can transmit returned data 114 as a single bundle. As such, the ONLD scheme can result in DMC 110 collecting all data 142 related to request for data 112, holding data 142 until all data is collected, bundling data 142 together and then returning data 142 as returned data 114 as a single bundle. This can result in a longer but more continuous return of data than would be expected under the IND scheme. The ONLD scheme can result in DMC 110 acting as a buffer that only returns data when all of the expected data has been collected. However, where DMC 110 is again expected to be faster than a client device request over an air interface without DMC 110, the buffering may still result in returned data 114 arriving faster than not employing DMC 110. Moreover, because the data is returned as a large bundle, rather than many smaller bundles, a receiving device's radio can be left in a non-IDLE state, e.g., the CR or DRX state, for an overall shorter period of time than can be expected of receiving many smaller data bundles that can cause a receiving device to be in the CR or DRX state for a period of time even though it is not receiving data for the whole period. This can result in energy savings at the receiving device. At a high level, IND can be viewed as low latency and moderate energy savings while ONLD can be viewed as moderate latency and high energy savings. Further, the ONLD scheme can allow DMC 110 to parse data 142 as it is collected so as to determine additional data that can be collected as related to request for data 112.

The PARCEL(X) scheme can transmit returned data 114 is a sequence of bundles of a certain data size or volume. In an aspect, PARCEL(X) can be viewed as a middle ground between IND and ONLD that can balance improved latency and improved energy savings. With PARCEL(X), DMC 110 can start transferring data to a client-side device as returned data 114 in data bundles of a certain size in relation to a determined bundle size value, see, for example, 506 of FIG. 5, etc. As such, PARCEL(X) does not need to wait for all data 142 to arrive at DMC 110. Further, PARCEL(X) can buffer and bundle data 142 to reduce the number, and increase the size, of data transfers via the air interface, e.g., returned data 114. In an aspect, PARCEL(X) can start transferring data to the client when a certain threshold of data, e.g., “(X)”, becomes available or if an Onload event is detected. This can allow objects, e.g., data 142, to transfer to the client from DMC 110 quickly while reducing the number of state transitions of the client radio. Further, other rules relating to determining the appropriate bundle size for PARCEL(X) can be employed. Moreover, PARCEL(X) can employ other triggers and/or rules to initiate a data bundle push from DMC 110 to the client via the air interface to adapt the data bundle size or initiate/prevent an immediate data object bundle transfer. Again, the PARCEL(X) scheme can allow DMC 110 to parse data 142 as it is collected so as to determine additional data that can be collected as related to request for data 112.

In an embodiment, data transfer functionality for system 100 can be distributed between a device, not illustrated, and DMC 110. Where the data transfer is, for example, associated with a traditional browser interaction, when a user enters or clicks a URL, a browser of the mobile device can generate a request for this URL, e.g., request for data 112, via an air interface to DMC 110. In response to receiving request for data 112, DMC 110 can perform DNS lookups and can request the URL, e.g., data 142, from the corresponding web server(s). On receiving the URL data, e.g., data 142, from the web server(s), DMC 110, rather than just forwarding them to the mobile device, can parse them to identify, by DMC 110, objects that can be needed to successfully render the page on the mobile device. This can include, for example, parsing an HTML page to identify objects in that page, processing JS to determine dependencies or point to objects that are dynamically identified, etc. DMC 110 can then request these additional data objects without needing to involve the mobile device, reducing the associated additional communications over the air interface between DMC 110 and the mobile device. Further, DMC 110 can apply compression and/or transformations, e.g., transcoding images, shrinking size, etc., to objects collected by the DMC, before transmitting them to the mobile device over the air interface, e.g., as returned data 114.

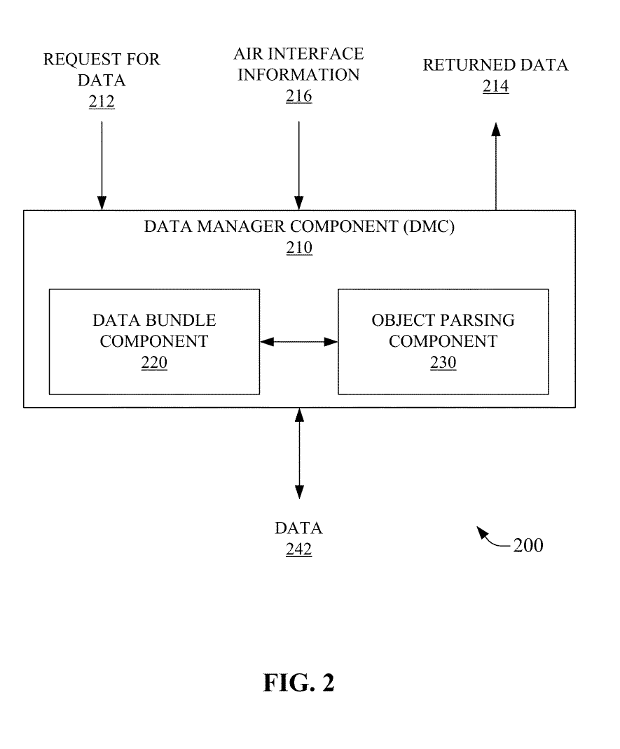

FIG. 2 is a depiction of a system 200 that can facilitate management of data transfer via a wireless interface based on air interface information in accordance with aspects of the subject disclosure. System 200 can include data management component (DMC) 210 that can receive request for data 212, receive air interface information 216, and facilitate access to requested data 214. DMC 210 can collect data 242. The collection of data 242 by DMC 210 can be in response to receiving request for data 212. Request for data 212 can be a request for nearly any type of data stored remote from a device associated with generating request for data 212. DMC 210 can receive request for data 212 and can act to gather the requested data. Gathering the requested data can include determining or resolving one or more data storage locations associated with the storage of said data. DMC 210 can then collect the requested data, e.g., data 242, from the determined or resolved data sources. DMC 210 can then return data 242 as returned data 214. Returned data 214 can be the same or different from data 242, e.g., data 242 can be transformed, modified, supplemented, altered, compiled or aggregated, filtered, sorted, bundled, or otherwise altered as part of returning returned data 214.

DMC 210 can be located on the opposite side of an air interface from a device associated with generating request for data 212. As an example, a device, not illustrated, can be a mobile device that can send request for data 212, via an air interface, that can be received by DMC 210 on the other side of the air interface. As such, DMC 210 can be generally associated with lower latency, higher bandwidth, and lower interference conditions for network connections that that associated with a device on the other side of the air interface, e.g., the client side of the air interface. Comparing access to data 242 for DMC 210 against direct access by a device on the client-side of an air interface, DMC 210 can be generally expected to be able to gather the data more quickly, at a higher rate, and with less interference than the client-side device would be able to achieve over the air interface. In an aspect, DMC 210 can function to push returned data 242 at a rate that can improve energy consumption of the client-side device in contrast to accessing data 242 in the absence of DMC 210, and can also improve the speed at which returned data 242 is received by the client-side device in contrast to access data 242 without DMC 210.

DMC 210 can pass data 242 back to a device associated with request for data 212 as returned data 214. Returned data 214 can be subject to air interface friendly schema that can comprise the IND scheme, the ONLD scheme, and the PARCEL(X) scheme, etc. The IND scheme can transmit returned data 214 as and when data 242 is collected, e.g., with no functional buffering data 242 is simply passed back as returned data 214. Whereas DMC 210 is typically expected to collect data 242 faster than a requesting device could over an air interface without DMC 210, returned data 214 can be expected to be returned at a relatively faster rate than a requesting device could collect data absent DMC 210. Further, the IND scheme can also allow DMC 210 to parse data 242 as it is collected so as to determine additional data that can be collected as related to request for data 212.

The ONLD scheme can transmit returned data 214 as a single bundle. As such, the ONLD scheme can result in DMC 210 collecting all data 242 related to request for data 212, holding data 242 until all data is collected, bundling data 242 together and then returning data 242 as returned data 214 as a single bundle. This can result in a longer but more continuous return of data than would be expected under the IND scheme. The ONLD scheme can result in DMC 210 acting as a buffer that only returns data when all of the expected data has been collected. However, where DMC 210 is again expected to be faster than a client device request over an air interface without DMC 210, the buffering may still result in returned data 214 arriving faster than not employing DMC 210. Moreover, because the data is returned as a large bundle, rather than many smaller bundles, a receiving device's radio can be left in a non-IDLE state, e.g., the CR or DRX state, for an overall shorter period of time than can be expected of receiving many smaller data bundles that can cause a receiving device to be in the CR or DRX state for a period of time even though it is not receiving data for the whole period. This can result in energy savings at the receiving device. At a high level, IND can be viewed as low latency and moderate energy savings while ONLD can be viewed as moderate latency and high energy savings. Further, the ONLD scheme can also allow DMC 210 to parse data 242 as it is collected so as to determine additional data that can be collected as related to request for data 212.

The PARCEL(X) scheme can transmit returned data 214 is a sequence of bundles of a certain data size or volume. In an aspect, PARCEL(X) can be viewed as a middle ground between IND and ONLD that can balance improved latency and improved energy savings. With PARCEL(X), DMC 210 can start transferring data to a client-side device as returned data 214 in data bundles of a certain size in relation to a determined bundle size value, see, for example, 506 of FIG. 5, etc. As such, PARCEL(X) does not need to wait for all data 242 to arrive at DMC 210. Moreover, the PARCEL(X) scheme can also allow DMC 210 to parse data 242 as it is collected to determine additional data that can be collected as related to request for data 212. Further, PARCEL(X) can buffer and bundle data 242 to reduce the number, and increase the size, of data transfers via the air interface, e.g., returned data 214. In an aspect, PARCEL(X) can start transferring data to the client when a certain threshold of data, e.g., “(X)”, becomes available or if an Onload event is detected. This can allow objects, e.g., data 242, to transfer to the client from DMC 210 quickly while reducing the number of state transitions of the client radio. Further, other rules relating to determining the appropriate bundle size for PARCEL(X) can be employed. Moreover, PARCEL(X) can employ other triggers and/or rules to initiate a data bundle push from DMC 210 to the client via the air interface to adapt the data bundle size or initiate/prevent an immediate data object bundle transfer.

As such, DMC 210 can comprise data bundle component 220 and object parsing component 230. Data bundle component 220 can bundle data 242 collected by DMC 210 and additional data collected by DMC 210 resulting from analysis of parsed data 242. The bundles can be as small as the individual data objects collected that comprises data 242, e.g., as and when a data object is collected by DMC 210 and as would be expected in the IND scheme. Further, the bundles can be as bid as all collected data, e.g., data 242 and additional data related to the parse analysis of data 242, and as would be expected for the ONLD scheme. Further, the bundles from data bundle component 220 can be some but not all collected data, e.g., data 242 and additional parse analysis related data, and as would be expected to be returned under a PARCEL(X) scheme. In an aspect, data bundle component 220 can bundle collected data in accord with the determined bundle size value mentioned in discussion related to the PARCEL(X) scheme, etc. Moreover, whereas the conditions of the air interface can affect the transfer of returned data 214, air interface information 216 can be received by DMC 210 and can be associated with determine bundle sizes via data bundle component 220. As an example, where air interface conditions rapidly deteriorate, smaller bundles can be subject to less loss than larger bundles, as such, Air interface information 216 can reflect the deteriorating conditions such that DMC 210 can shift to smaller bundles than might otherwise be generated for returned data 214. Similarly, where the air interface is better than expected, this information can be employed to increase bundle sizes in accord with other bundle size considerations. In an aspect, air interface information 216 can also comprise information related to the characteristics of a device generating request for data 212, in addition to, or as a substitute for, such information being received by DMC 210, for example, battery conditions, radio types or characteristics, display sizes or resolutions, etc.

Object parsing component 230 can parse collected data 242 to facilitate determinations about additional data or object that can be collected in relation to request for data 212. As an example, where a request is for a webpage that has advertising that changes on with a user input hover activity, the objects representing the several states of the advertisement can be also collected and returned to allow the change in the advertising state without a further request by the client.

In an embodiment, data transfer functionality for system 200 can be distributed between a client that can generate request for data 212 and DMC 210. Where the data transfer is, for example, associated with a traditional browser interaction, when a user enters or clicks a URL, a browser of the mobile device can generate a request for this URL, e.g., request for data 212, via an air interface to DMC 210. In response to receiving request for data 212, DMC 210 can perform, for example, DNS lookups and can request the URL, e.g., data 242, from the corresponding web server(s). On receiving the URL data, e.g., data 242, from the web server(s), DMC 210, rather than just forwarding them to the mobile device, can parse them to identify, by DMC 210, objects that can be needed for the webpage. This can include, for example, parsing an HTML page to identify objects in that page, processing JS to determine dependencies or point to objects that are dynamically identified, etc. DMC 210 can then request these additional data objects without needing to involve the mobile device, reducing the associated additional communications over the air interface between DMC 210 and the mobile device. Further, DMC 210 can apply compression and/or transformations, e.g., transcoding images, shrinking size, etc., to objects collected by the DMC, before transmitting them to the mobile device over the air interface, e.g., as returned data 214.

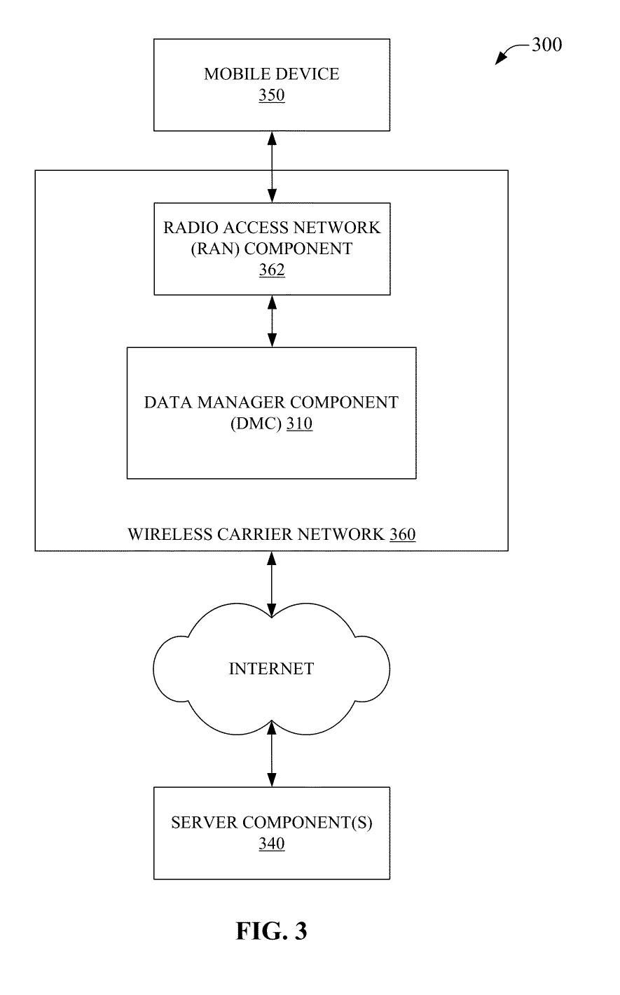

FIG. 3 illustrates a system 300 that facilitates management of data transfer via a wireless interface comprising a radio access network component in accordance with aspects of the subject disclosure. System 300 can include data management component (DMC) 310 that can receive request for data from mobile device 350 via RAN component 362 and facilitate access to requested data by mobile device 350. DMC 310 can collect data from server component(s) 340 via the Internet. The collection of data by DMC 310 can be in response to receiving request for data from mobile device 350. The request for data can be a request for nearly any type of data stored remote from mobile device 350. DMC 310 can receive the request for data and can act to gather the requested data. Gathering the requested data can include determining or resolving one or more data storage locations associated with the storage of said data, e.g., resolving a network location(s) of server component(s) 340. DMC 310 can then collect the requested data, from the determined or resolved data sources, e.g., server component(s) 340. DMC 310 can then return the data to mobile device 350. Returning the data can be by a data push function that doesn't require additional communication overhead across the air interface. Returned data can be the same or different from data collected from server component(s) 340, e.g., collected data can be transformed, modified, supplemented, altered, compiled or aggregated, filtered, sorted, bundled, or otherwise altered as part of returning returned data to mobile device 350. As an example, a request for data can comprise a URL for a webpage such that DMC 310 resolves the location of objects related to the URL and collects said objects from their corresponding server component(s) 340, before returning a bundle of said objects to mobile device 350, which can enable mobile device 350, at least in part, to display the webpage associated with the URL.

DMC 310 can be located on the opposite side of an air interface from mobile device 350. In an embodiment of system 300, wireless carrier network 360 can comprise DMC 310. Further, in some embodiments, DMC can be located on the carrier-side of RAN component 360, e.g., a NodeB, eNodeB, femotocell, etc. As an example, mobile device 350 can send a request for data, via an air interface, which can be received by RAN component 362 as part of wireless carrier network 360. RAN component 362 can pass the request to DMC 310. DMC 310 can reside behind RAN component 362 such that radio transmissions comprising the request for data from a smartphone device, e.g., mobile device 350, can be communicated to DMC 310 via the air interface enabled by the RAN device. As such, DMC 310 can be generally associated with lower latency, higher bandwidth, and lower interference conditions for network connections that that associated with a device on the other side of the air interface, e.g., the client side of the air interface. This is generally due to the air interface itself being slower, more constricted, and subject to interferers, in contrast to a carrier-side network, often a wired network, where DMC 310 can generally be located. Comparing access to data located at server component(s) 340 for DMC 310 against direct access by a mobile device 350 on the client-side of an air interface, DMC 310 can be generally expected to be able to gather the data more quickly, at a higher rate, and with less data corruption than the client-side device would be able to achieve over the air interface. In an aspect, DMC 310 can serve as a buffer, of sorts, for the collected data, e.g., collecting it faster than the client-side device could over the air interface and then returning collected data as returned data to mobile device 350 in a manner that conforms to the particular nature of the air interface. This can function to push returned data at a rate that can improve energy consumption of mobile device 350 in contrast to accessing data stored at server component(s) 340 in the absence of DMC 310, and can also improve the speed at which returned data is received by the mobile device 350 in contrast to accessing data stored at server component(s) 340 without DMC 310.

DMC 310 can pass data stored at server component(s) 340 back to mobile device 350. Returned data can be subject to air interface friendly schema that can comprise the IND scheme, the ONLD scheme, and the PARCEL(X) scheme, etc. The IND scheme can transmit returned data as and when data stored at server component(s) 340 is collected, e.g., with no functional buffering data is simply passed back to mobile device 350. Whereas DMC 310 is typically expected to collect data stored at server component(s) 340 faster than a mobile device 350 could over an air interface without DMC 310, returned data can be expected to be returned at a relatively faster rate than a mobile device 350 could collect data absent DMC 310. Further, the IND scheme can also allow DMC 310 to parse collected data from server component(s) 340 so as to determine additional data that can be collected as related to a request for data. As an example, where collected data is related to a webpage having javascript (JS), DMC 310 can emulate the execution of the JS to determine additional object that should be collected and then supplied to the requesting device, e.g., mobile device 350, via returned data.

The ONLD scheme can transmit returned data as a single bundle to mobile device 350. As such, the ONLD scheme can result in DMC 310 collecting all data stored at server component(s) 340 related to a request for data, holding the collected data until all data is collected, bundling the collected data together and then returning it to mobile device 350 as a single bundle. This can result in a longer but more continuous return of data than would be expected under the IND scheme. The ONLD scheme can result in DMC 310 acting as a buffer that only returns data when all of the expected data has been collected. However, where DMC 310 is again expected to be faster than a mobile device 350 requesting data over an air interface without DMC 310, the buffering may still result in returned data arriving faster than not employing DMC 310. Moreover, because the data is returned as a large bundle, rather than many smaller bundles, a radio of mobile device 350 can be left in a non-IDLE state, e.g., the CR or DRX state, for an overall shorter period of time than can be expected of receiving many smaller data bundles that can cause a receiving device to be in the CR or DRX state for a period of time even though it is not receiving data for the whole period. This can result in energy savings at the mobile device 350. At a high level, IND can be viewed as low latency and moderate energy savings while ONLD can be viewed as moderate latency and high energy savings. Further, the ONLD scheme can allow DMC 310 to parse data as it is collected from server component(s) 340 so as to determine additional data that can be collected as related to the request for data.

The PARCEL(X) scheme can transmit returned data is a sequence of bundles of a determined data size or volume. In an aspect, PARCEL(X) can be viewed as a middle ground between IND and ONLD that can balance improved latency and improved energy savings. With PARCEL(X), DMC 310 can start transferring data to a mobile device 350 in data bundles of a determined size in relation to a determined bundle size value, see, for example, 506 of FIG. 5, etc. As such, PARCEL(X) does not need to wait for all data to arrive from server component(s) 340. Further, PARCEL(X) can buffer and bundle data to alter the number, and alter the size, of data transfers via the air interface. In an aspect, PARCEL(X) can start transferring data to the client when a certain threshold of data, e.g., “(X)”, becomes available or if an Onload event is detected. This can allow objects to transfer to mobile device 350 from DMC 310 quickly while reducing the number of state transitions of the client radio. Further, other rules relating to determining the appropriate bundle size for PARCEL(X) can be employed. Moreover, PARCEL(X) can employ other triggers and/or rules to initiate a data bundle push from DMC 310 to the client via the air interface to adapt the data bundle size or initiate/prevent an immediate data object bundle transfer. Again, the PARCEL(X) scheme can allow DMC 210 to parse data as it is collected from server component(s) 340 so as to determine additional data that can be collected as related to the request for data from mobile device 350.

In an embodiment, data transfer functionality for system 300 can be distributed between mobile device 350 and DMC 310. Where the data transfer is, for example, associated with a traditional browser interaction, when a user enters or clicks a URL, a browser of mobile device 350 can generate a request for this URL via an air interface to DMC 310. In response to receiving the request for data, DMC 310 can perform DNS lookups and can request the URL data stored at server component(s) 340. On receiving the URL data from the web server(s), e.g., server component(s) 340, DMC 310, rather than just forwarding them to the mobile device, can parse them to identify, by DMC 310, objects that can be needed to successfully render the page on mobile device 350. This can include, for example, parsing an HTML page to identify objects in that page, processing JS to determine dependencies or point to objects that are dynamically identified, etc. DMC 310 can then request these additional data objects without needing to involve mobile device 350, reducing the associated additional communications over the air interface between DMC 310 and mobile device 350. Further, DMC 310 can apply compression and/or transformations, e.g., transcoding images, shrinking size, etc., to objects collected by the DMC, before transmitting them to mobile device 350 over the air interface.

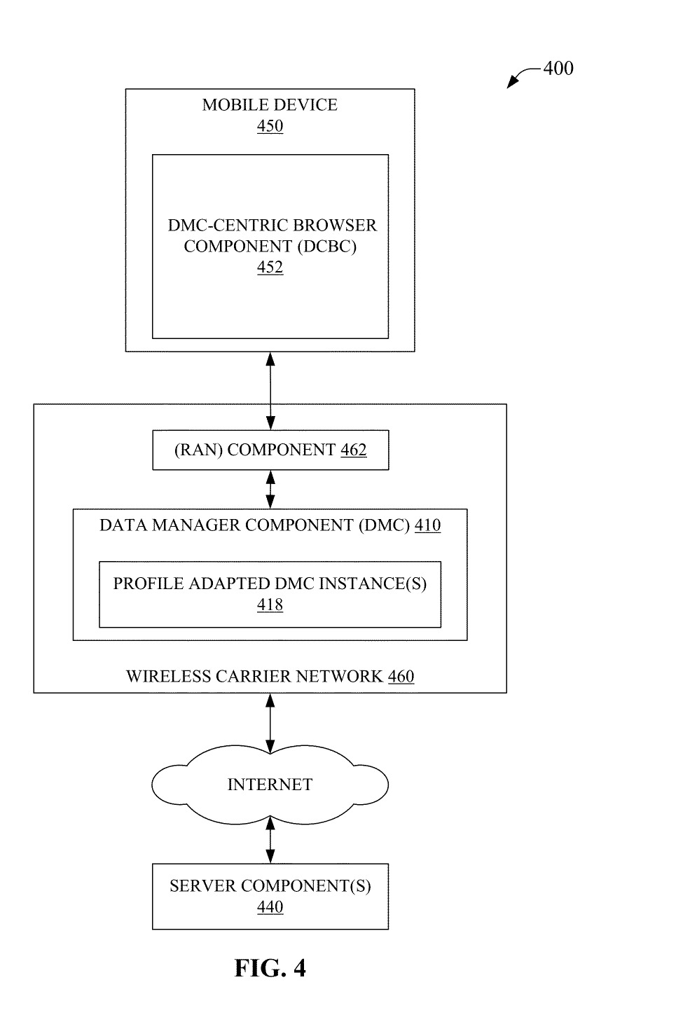

FIG. 4 illustrates a system 400 that facilitates management of data transfer via a wireless interface comprising a profile adapted data manager component instance in accordance with aspects of the subject disclosure. System 400 can include data management component (DMC) 410 that can receive request for data from mobile device 450 via RAN component 462 and facilitate access to requested data by mobile device 450. DMC 410 can collect data from server component(s) 440 via the Internet. The collection of data by DMC 410 can be in response to receiving request for data from mobile device 450. The request for data can be a request for nearly any type of data stored remote from mobile device 450. DMC 410 can receive the request for data and can act to gather the requested data. Gathering the requested data can include determining or resolving one or more data storage locations associated with the storage of said data, e.g., resolving a network location(s) of server component(s) 440. DMC 410 can then collect the requested data, from the determined or resolved data sources, e.g., server component(s) 440. DMC 410 can then return the data to mobile device 450. Returning the data can be by a data push function that doesn't require additional communication overhead across the air interface. Returned data can be the same or different from data collected from server component(s) 440, e.g., collected data can be transformed, modified, supplemented, altered, compiled or aggregated, filtered, sorted, bundled, or otherwise altered as part of returning returned data to mobile device 450. As an example, a request for data can comprise a URL for a webpage such that DMC 410 resolves the location of objects related to the URL and collects said objects from their corresponding server component(s) 440, before returning a bundle of said objects to mobile device 450, which can enable mobile device 450, at least in part, to display the webpage associated with the URL.

DMC 410 can be located on the opposite side of an air interface from mobile device 450. In an embodiment of system 400, wireless carrier network 460 can comprise DMC 410. Further, in some embodiments, DMC can be located on the carrier-side of RAN component 460, e.g., a NodeB, eNodeB, femotocell, etc. As an example, mobile device 450 can send a request for data, via an air interface, which can be received by RAN component 462 as part of wireless carrier network 460. RAN component 462 can pass the request to DMC 410. DMC 410 can reside behind RAN component 462 such that radio transmissions comprising the request for data from a smartphone device, e.g., mobile device 450, can be communicated to DMC 410 via the air interface enabled by the RAN device. As such, DMC 410 can be generally associated with lower latency, higher bandwidth, and lower interference conditions for network connections that that associated with a device on the other side of the air interface, e.g., the client side of the air interface. This is generally due to the air interface itself being slower, more constricted, and subject to interferers, in contrast to a carrier-side network, often a wired network, where DMC 410 can generally be located. Comparing access to data located at server component(s) 440 for DMC 410 against direct access by a mobile device 450 on the client-side of an air interface, DMC 410 can be generally expected to be able to gather the data more quickly, at a higher rate, and with less data corruption than the client-side device would be able to achieve over the air interface. In an aspect, DMC 410 can serve as a buffer, of sorts, for the collected data, e.g., collecting it faster than the client-side device could over the air interface and then returning collected data as returned data to mobile device 450 in a manner that conforms to the particular nature of the air interface. This can function to push returned data at a rate that can improve energy consumption of mobile device 450 in contrast to accessing data stored at server component(s) 440 in the absence of DMC 410, and can also improve the speed at which returned data is received by the mobile device 450 in contrast to accessing data stored at server component(s) 440 without DMC 410.

DMC 410 can pass data stored at server component(s) 440 back to mobile device 450. Returned data can be subject to air interface friendly schema that can comprise the IND scheme, the ONLD scheme, and the PARCEL(X) scheme, etc. The IND scheme can transmit returned data as and when data stored at server component(s) 440 is collected, e.g., with no functional buffering data is simply passed back to mobile device 450. Whereas DMC 410 is typically expected to collect data stored at server component(s) 440 faster than a mobile device 450 could over an air interface without DMC 410, returned data can be expected to be returned at a relatively faster rate than a mobile device 450 could collect data absent DMC 410. Further, the IND scheme can also allow DMC 410 to parse collected data from server component(s) 440 so as to determine additional data that can be collected as related to a request for data. As an example, where collected data is related to a webpage having javascript (JS), DMC 410 can emulate the execution of the JS to determine additional object that should be collected and then supplied to the requesting device, e.g., mobile device 450, via returned data.

The ONLD scheme can transmit returned data as a single bundle to mobile device 450. As such, the ONLD scheme can result in DMC 410 collecting all data stored at server component(s) 440 related to a request for data, holding the collected data until all data is collected, bundling the collected data together and then returning it to mobile device 450 as a single bundle. This can result in a longer but more continuous return of data than would be expected under the IND scheme. The ONLD scheme can result in DMC 410 acting as a buffer that only returns data when all of the expected data has been collected. However, where DMC 410 is again expected to be faster than a mobile device 450 requesting data over an air interface without DMC 410, the buffering may still result in returned data arriving faster than not employing DMC 410. Moreover, because the data is returned as a large bundle, rather than many smaller bundles, a radio of mobile device 450 can be left in a non-IDLE state, e.g., the CR or DRX state, for an overall shorter period of time than can be expected of receiving many smaller data bundles that can cause a receiving device to be in the CR or DRX state for a period of time even though it is not receiving data for the whole period. This can result in energy savings at the mobile device 450. At a high level, IND can be viewed as low latency and moderate energy savings while ONLD can be viewed as moderate latency and high energy savings. Further, the ONLD scheme can allow DMC 410 to parse data as it is collected from server component(s) 440 so as to determine additional data that can be collected as related to the request for data.

The PARCEL(X) scheme can transmit returned data is a sequence of bundles of a determined data size or volume. In an aspect, PARCEL(X) can be viewed as a middle ground between IND and ONLD that can balance improved latency and improved energy savings. With PARCEL(X), DMC 410 can start transferring data to a mobile device 450 in data bundles of a determined size in relation to a determined bundle size value, see, for example, 506 of FIG. 5, etc. As such, PARCEL(X) does not need to wait for all data to arrive from server component(s) 440. Further, PARCEL(X) can buffer and bundle data to alter the number, and alter the size, of data transfers via the air interface. In an aspect, PARCEL(X) can start transferring data to the client when a certain threshold of data, e.g., “(X)”, becomes available or if an Onload event is detected. This can allow objects to transfer to mobile device 450 from DMC 410 quickly while reducing the number of state transitions of the client radio. Further, other rules relating to determining the appropriate bundle size for PARCEL(X) can be employed. Moreover, PARCEL(X) can employ other triggers and/or rules to initiate a data bundle push from DMC 410 to the client via the air interface to adapt the data bundle size or initiate/prevent an immediate data object bundle transfer. Again, the PARCEL(X) scheme can allow DMC 210 to parse data as it is collected from server component(s) 440 so as to determine additional data that can be collected as related to the request for data from mobile device 450.

In an embodiment, data transfer functionality for system 400 can be distributed between mobile device 450 and DMC 410. Where the data transfer is, for example, associated with a traditional browser interaction, when a user enters or clicks a URL, a browser of mobile device 450 can generate a request for this URL via an air interface to DMC 410. In response to receiving the request for data, DMC 410 can perform DNS lookups and can request the URL data stored at server component(s) 440. On receiving the URL data from the web server(s), e.g., server component(s) 440, DMC 410, rather than just forwarding them to the mobile device, can parse them to identify, by DMC 410, objects that can be needed to successfully render the page on mobile device 450. This can include, for example, parsing an HTML page to identify objects in that page, processing JS to determine dependencies or point to objects that are dynamically identified, etc. DMC 410 can then request these additional data objects without needing to involve mobile device 450, reducing the associated additional communications over the air interface between DMC 410 and mobile device 450. Further, DMC 410 can apply compression and/or transformations, e.g., transcoding images, shrinking size, etc., to objects collected by the DMC, before transmitting them to mobile device 450 over the air interface.

In an aspect, mobile device 450 can comprise DMC-centric browser component (DCBC) 452. DCBC 452 can be a browser adapted or designed to interface with DMC 410. In an embodiment, DCBC 452 can provide information related to the air interface, bundle preference information, user profile information, etc. This information can facilitate interactions with DMC 410, such as, determining use of IND, ONLD, or PARCEL(X) scheme, determining a bundle size, or instantiating a profile adapted DMC instant 418.

DMC 410 can comprise profile adapted DMC instance(s) 418 that can facilitate individually adapted DMC functionality enabling additional functionality in the division of functionality between the carrier-side, e.g., DMC 410 and client-side, e.g., mobile device 450. As an example, handling encrypted data or pages can, in an embodiment not employing profile adapted DMC instance(s) 418, be accomplished by causing the DMC to fall back to the traditional way of downloading web pages since the DMC can have difficulty parsing and identify objects needed for such pages. However, using profile adapted DMC instance(s) 418, can allow the user to indicate trust such that the DMC can allow HTTPS requests to be properly handled by setting up independent secure channels between the client and the data server. Similarly, DMC 410 can handle POST requests by relaying them to server component(s) 440 as received from the mobile device 450. If the POST response from server component(s) 440 is HTML, DMC 410 can processes the response as previously explained before sending it to the mobile device 450. For HTTP responses that do not have content, e.g., HTTP 204, DMC 410 can forward this unmodified to the mobile device 450.

FIG. 5 illustrates example data bundling schema related to management of data transfer via a wireless interface in accordance with aspects of the subject disclosure. Scheme 500 illustrates conventional client-server interactions comprising requests from the client, e.g., 510, 520, 530 and further comprising server replies, e.g., 511, 521, and 531. Scheme 500 is provided for reference so as to better illustrate the difference from Schema 502, 504, and 506, and is not presented to limit the disclosure in any way.

Scheme 502 illustrates incorporating a DMC between the client and server. Moreover, scheme 502 can represent an IND-type scheme as previously disclosed. In the IND scheme, a DMC can transfer data objects to a client via the air interface, as and when the DMC receives the objects. As can been seen in 502, the client can generate a single request, e.g., 512. This request can be employed by DMC to collect data from the server. As data is collected by the DMC, it can be immediately bundled and returned to the client, e.g., 522, etc. Further, DMC can parse the data returned by the server to determine additional data related to the request, also as previously disclosed. This additional data can also be returned to the client as it is received from the server by the DMC, e.g., 532, 542, 552, etc. The IND-type scheme illustrated in 502 can reducing energy consumption and, further, can reduce OLT because it can relieve the client from making subsequent data requests, e.g., scheme 500 has three requests (510, 520, 530) in contrast to scheme 502 having only one request (512), and can allow the client to start processing HTML and JS objects as they arrive from the DMC via the air interface.

Scheme 504 also illustrates incorporation of a DMC between the client and server. Moreover, scheme 504 can represent an ONLD-type scheme as previously disclosed. As can been seen in 504, the client can generate a single request, e.g., 514. This request can be employed by DMC to collect data from the server. In the ONLD scheme, the DMC can fetch objects from a web server(s) and can transmit the data in a single bundle to the client. Scheme 504 illustrates this by collecting data at the DMC from the server down to point 524, e.g., an Onload event, at which time data 534 can be returned to the client. ONLD can exchange increased OLT, as compared to the IND scheme, and further reductions in energy consumption because the client can go into an IDLE state while the DMC is downloading data and then can receive all the data as a single bundle from the DMC. Further, the DMC can parse the data returned by the server to determine additional data related to the request, also as previously disclosed. This additional data can also be returned to the client, even after point 524, in an additional bundle of data from the server, e.g., 544. Moreover, scheme 504 can relieve the client from making subsequent data requests, e.g., scheme 500 has three requests (510, 520, 530) in contrast to scheme 504 having only one request (514).

Scheme 506 illustrates incorporation of a DMC between the client and server. Moreover, scheme 506 can represent a PARCEL(X)-type scheme as previously disclosed. As can been seen in 506, the client can generate a single request, e.g., 516. This request can be employed by DMC to collect data from the server. In the PARCEL(X) scheme, the DMC can select or determine a bundle size value that can be employed to strike a balance between the latency and energy benefits found in IND and ONLD. With PARCEL(X), the DMC can start transferring data to the client in data bundles of a certain size in relation to the bundle size value, e.g., 526 and 536. As such, PARCEL(X) does not need to wait for all data objects to arrive at the DMC, e.g., as can be found in instances of ONLD. Further, PARCEL(X) can buffer and bundle data objects to reduce the number, and increase the size, of data transfers via the air interface, in contrast to IND. PARCEL(X) can starts transferring data to the client when a certain threshold of data, e.g., “(X)”, becomes available or if the Onload event is detected. This can allows objects to transfer to the client from the DMC quickly while reducing the number of state transitions of the client radio. Further, the DMC can parse the data returned by the server to determine additional data related to the request, also as previously disclosed. This additional data can also be returned to the client, in an additional bundle of data from the server, e.g., 546. Moreover, scheme 506 can relieve the client from making subsequent data requests, e.g., scheme 500 has three requests (510, 520, 530) in contrast to scheme 506 having only one request (516). It can be seen in FIG. 5 that scheme 506 has more frequent data returns that scheme 504 and less frequent returns than scheme 502 and can be viewed as a “goldilocks” scheme that balances low latency against reduced power consumption as disclosed elsewhere herein.

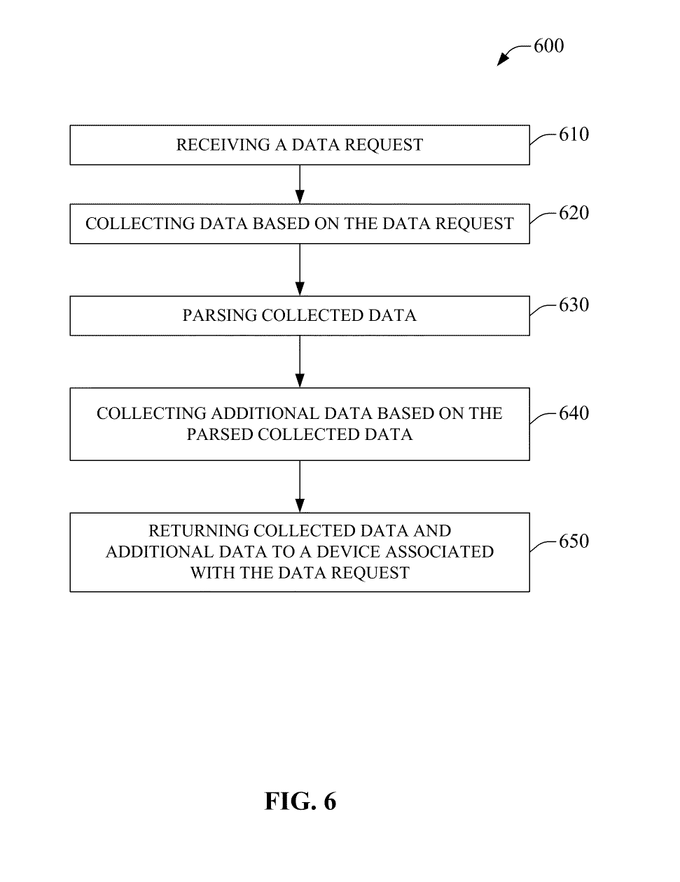

In view of the example system(s) described above, example method(s) that can be implemented in accordance with the disclosed subject matter can be better appreciated with reference to flowcharts in FIG. 6-FIG. 8. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, two or more of the disclosed example methods can be implemented in combination with each other, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 6 illustrates a method 600 facilitating management of data transfer via a wireless interface in accordance with aspects of the subject disclosure. At 610, method 600 can include receiving a data request. The data request can, in an embodiment be received from a mobile device on the opposite side of an air interface from a device applying method 600, e.g., a mobile device as discloses elsewhere herein.

At 620, method 600 can comprise collecting data based on the data request. In an aspect, data can be collected from data stores located remote from a device associated with generating the data request received at 610. In an embodiment, where the received data request from 610 is a request for a webpage related to a URL, the data collected at 620 can comprise the objects of the webpage and can be collected from webservers associated with the URL.

At 630, method 600 can comprise, parsing the collected data. Parsing data collected at 620 before returning it to a requestor, see 650, can facilitate collecting additional data related to the request from 610. Parsing can facilitate determinations about additional data or objects that can be collected in relation to request for data 610. As an example, where a request is for a webpage that has advertising that changes based on a user action, the objects representing the several states of the advertisement can be also collected at 640 and returned at 650 to allow the change in the advertising state to occur at the client in response to the user action without initiating further requests by the client.

At 640, method 600 can comprise, collecting additional data based on the parsed collected data from 630. Where the parsing facilitated a determination about additional data or objects that can be collected in relation to request for data 610, these additional data or object can be collected at 640.

At 650, method 600 can comprise, returning collected data and additional data to a device associated with the data request of 610. At this point method 600 can end. At 650, the single request for data from 610 has resulted in the collection of associated data, parsing of that data, collection of additional data based on the parsing, and this data, e.g., the collected data from 620 and the additional data from 640, can then be returned to a requesting device. In an embodiment returning the data can be in accord with the IND, ONLD, or PARCEL(X) schema as disclosed elsewhere herein.

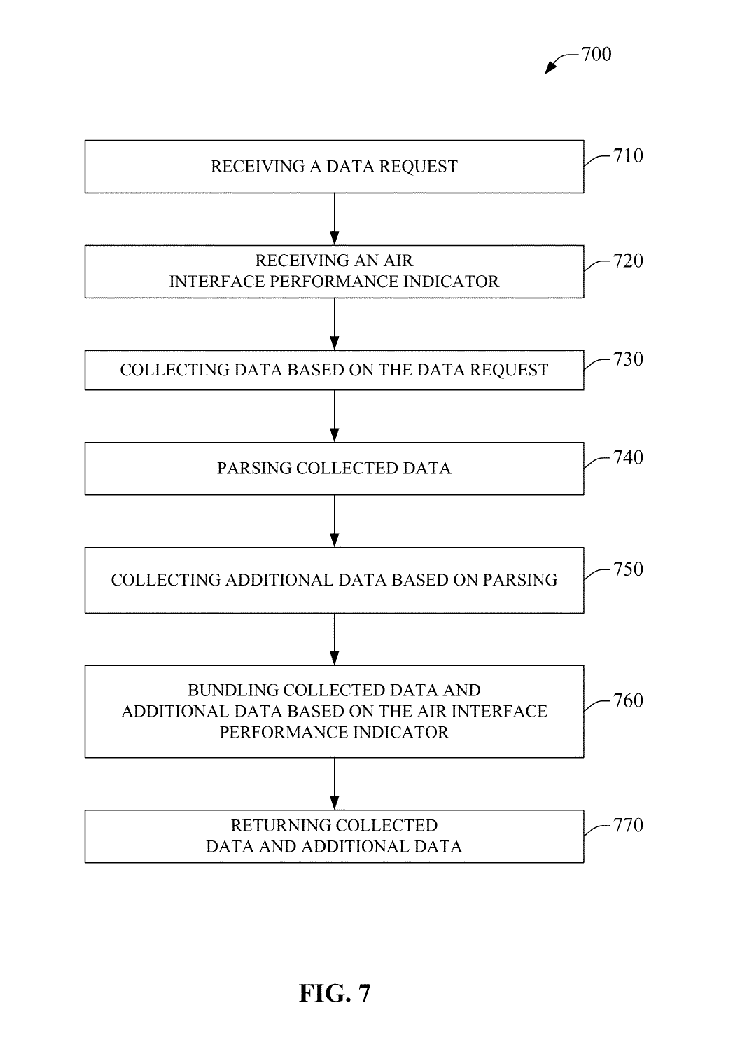

FIG. 7 illustrates a method 700 that facilitates management of data transfer via a wireless interface based on air interface information in accordance with aspects of the subject disclosure. At 710, method 700 can include receiving a data request. The data request can, in an embodiment be received from a mobile device on the opposite side of an air interface from a device applying method 700, e.g., a mobile device as discloses elsewhere herein.

At 720, an air interface performance indicator can be received. Air interface performance indicator can be associated with determining bundle sizes for returning data to a client device. As an example, where air interface conditions rapidly deteriorate, smaller bundles can be subject to less loss than larger bundles, as such, an air interface performance indicator can reflect the deteriorating conditions such that smaller bundles than might otherwise be generated for returned data. Similarly, where the air interface is better than expected, this information can be employed to increase bundle sizes in accord with other bundle size considerations. In an aspect, an air interface performance indicator can also comprise information related to the characteristics of a device generating the request for data received at 710, for example, battery conditions, radio types or characteristics, display sizes or resolutions, etc., as these can be associated with suitability of the performance of the air interface as a function of bundle size.

At 730, method 700 can comprise collecting data based on the data request from 710. In an aspect, data can be collected from data stores located remote from a device associated with generating the data request received at 710. In an embodiment, where the received data request from 710 is a request for a webpage related to a URL, the data collected at 730 can comprise the objects of the webpage and can be collected from webservers associated with the URL.

At 740, method 700 can comprise, parsing the collected data. Parsing data collected at 730 before returning it to a requestor can facilitate collecting additional data related to the request from 710. Parsing can facilitate determinations about additional data or objects that can be collected in relation to request for data 710. As an example, where a request is for a webpage that has advertising that changes based on a user action, the objects representing the several states of the advertisement can be also collected at 750 and returned at 770 to allow the change in the advertising state to occur at the client in response to the user action without initiating further requests by the client.

At 750, method 700 can comprise, collecting additional data based on the parsed collected data from 730. Where the parsing facilitated a determination about additional data or objects that can be collected in relation to request for data 710, these additional data or object can be collected at 750.

At 760, collected data and additional data can be bundled. The bundle size can be based on the air interface performance indicator received at 720. As previously stated, an air interface performance indicator can be associated with determining bundle sizes for returning data to a client device, such as, where air interface conditions rapidly deteriorate, smaller bundles can be subject to less loss than larger bundles and an air interface performance indicator can reflect the deteriorating conditions. Similarly, where the air interface is better than expected, this information can be employed to increase bundle sizes in accord with other bundle size considerations.

At 770, method 700 can comprise, returning collected data and additional data to a device associated with the data request of 710. At this point method 700 can end. At 770, the single request for data from 710 has resulted in the collection of associated data, parsing of that data, collection of additional data based on the parsing, and this data, e.g., the collected data from 730 and the additional data from 750, can then be returned to a requesting device. In an embodiment returning the data can be in accord with the IND, ONLD, or PARCEL(X) schema as disclosed elsewhere herein.

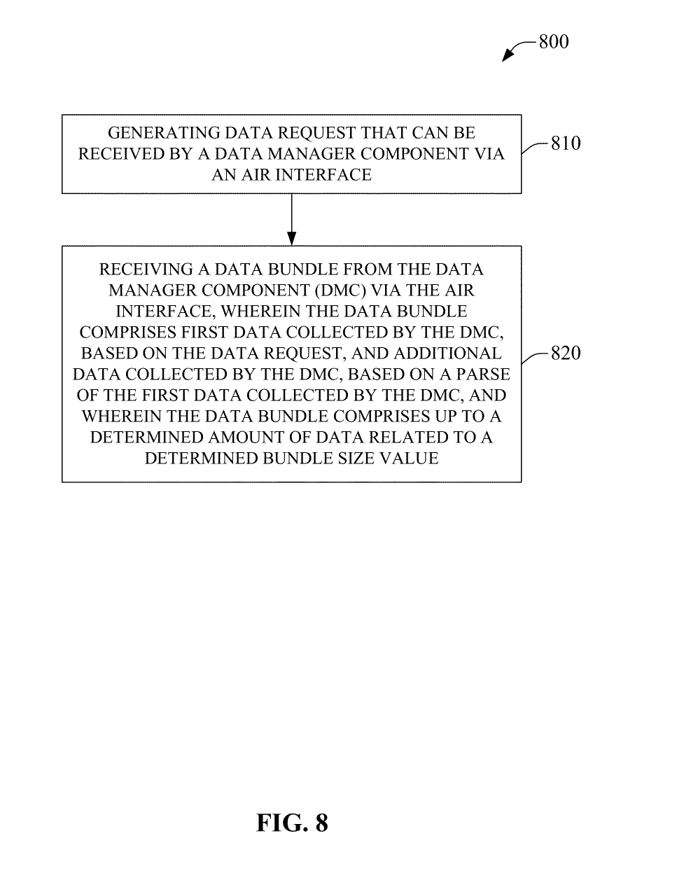

FIG. 8 illustrates a method 800 that facilitates receiving a data bundle related to management of data transfer via a interface network in accordance with aspects of the subject disclosure. At 810, method 800 can include generating a data request that can be received by a DMC component via an air interface. In an embodiment, a mobile device can communicate a data request that can be received by a DMC via an air interface, such as, where the DMC is located in a carrier network component. The generated data request can comprise identification of the requested data, locations of the requested data, air interface information, device information, profile information, etc., as previously disclosed, to facilitate DMC operations.

At 820, method 800 can comprise receiving a data bundle from the DMC component via the air interface. At this point method 800 can end. In an aspect, the data bundle can comprise first data collected by the DMC based on the data request from 810. Further, the data bundle can comprise additional data collected by the DMC based on a parse of the first data. This can facilitate returning objects or data with dependencies as disclosed herein. Still further, the data bundle can comprise up to a determined amount of data that is related to a determined bundle size value. In an embodiment, the determined bundle size value can enable an IND-type data return scheme. In another embodiment, the determined bundle size value can enable an ONLD-type data return scheme. In further embodiment, the determined bundle size value can enable a PARCEL(X)-type data return scheme. In some embodiments, the determined bundle size value can be adapted based on air interface information as disclosed herein.

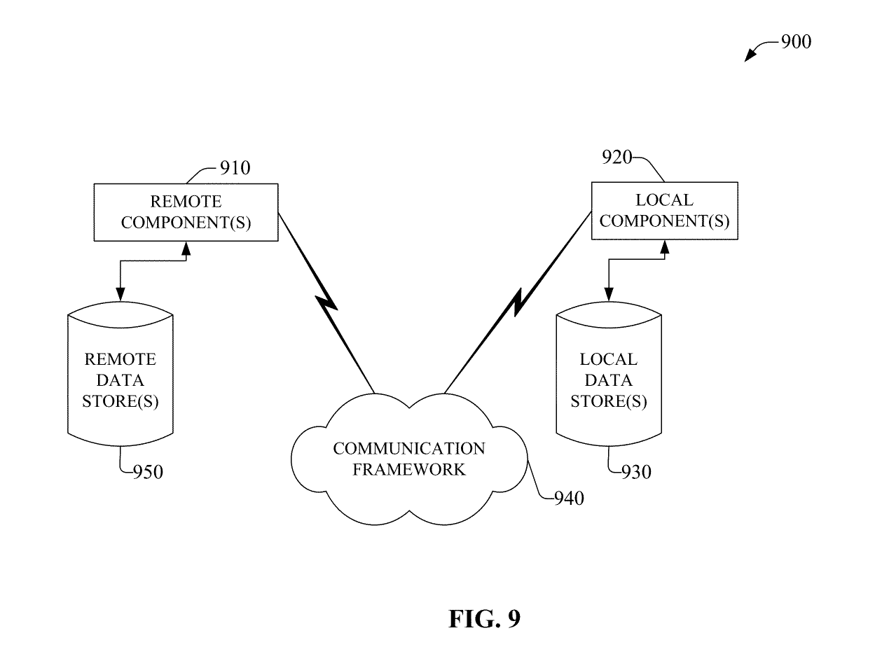

FIG. 9 is a schematic block diagram of a computing environment 900 with which the disclosed subject matter can interact. The system 900 includes one or more remote component(s) 910. The remote component(s) 910 can be hardware and/or software (e.g., threads, processes, computing devices). In some embodiments, remote component(s) 910 can include servers, personal servers, wireless telecommunication network devices, etc. As an example, remote component(s) 910 can be a DMC 110, 210, 310, 410, RAN component 362, 462, server component(s) 340, 440, etc.

The system 900 also includes one or more local component(s) 920. The local component(s) 920 can be hardware and/or software (e.g., threads, processes, computing devices). In some embodiments, local component(s) 920 can include, for example, mobile device 350, 450, etc.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 includes a communication framework 940 that can be employed to facilitate communications between the remote component(s) 910 and the local component(s) 920, and can include an air interface, e.g., Uu interface of a UMTS network. Remote component(s) 910 can be operably connected to one or more remote data store(s) 950, such as a hard drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

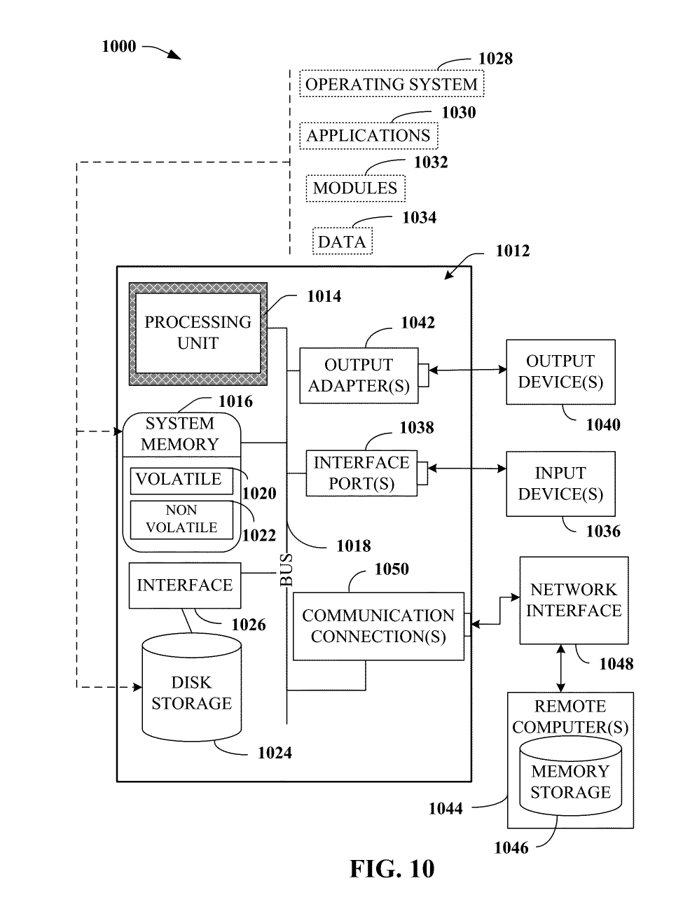

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules include routines, programs, components, data structures, etc. that performs particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It is noted that the memory components described herein can be either volatile memory or nonvolatile memory, or can include both volatile and nonvolatile memory, by way of illustration, and not limitation, volatile memory 1020 (see below), non-volatile memory 1022 (see below), disk storage 1024 (see below), and memory storage 1046 (see below). Further, nonvolatile memory can be included in read only memory, programmable read only memory, electrically programmable read only memory, electrically erasable read only memory, or flash memory. Volatile memory can include random access memory, which acts as external cache memory. By way of illustration and not limitation, random access memory is available in many forms such as synchronous random access memory, dynamic random access memory, synchronous dynamic random access memory, double data rate synchronous dynamic random access memory, enhanced synchronous dynamic random access memory, Synchlink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, including single-processor or multiprocessor computer systems, mini-computing devices, mainframe computers, as well as personal computers, hand-held computing devices (e.g., personal digital assistant, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012, which can be, for example, part of DMC 110, 210, 310, 410, mobile device 350, 450, server component(s) 340, 440, RAN component 362, 462, etc., includes a processing unit 1014, a system memory 1016, and a system bus 1018. System bus 1018 couples system components including, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) including a memory bus or a memory controller, a peripheral bus or an external bus, and/or a local bus using any variety of available bus architectures including, but not limited to, industrial standard architecture, micro-channel architecture, extended industrial standard architecture, intelligent drive electronics, video electronics standards association local bus, peripheral component interconnect, card bus, universal serial bus, advanced graphics port, personal computer memory card international association bus, Firewire (Institute of Electrical and Electronics Engineers 1194), and small computer systems interface.

System memory 1016 can include volatile memory 1020 and nonvolatile memory 1022. A basic input/output system, containing routines to transfer information between elements within computer 1012, such as during start-up, can be stored in nonvolatile memory 1022. By way of illustration, and not limitation, nonvolatile memory 1022 can include read only memory, programmable read only memory, electrically programmable read only memory, electrically erasable read only memory, or flash memory. Volatile memory 1020 includes read only memory, which acts as external cache memory. By way of illustration and not limitation, read only memory is available in many forms such as synchronous random access memory, dynamic read only memory, synchronous dynamic read only memory, double data rate synchronous dynamic read only memory, enhanced synchronous dynamic read only memory, Synchlink dynamic read only memory, Rambus direct read only memory, direct Rambus dynamic read only memory, and Rambus dynamic read only memory.

Computer 1012 can also include removable/non-removable, volatile/non-volatile computer storage media. FIG. 10 illustrates, for example, disk storage 1024. Disk storage 1024 includes, but is not limited to, devices like a magnetic disk drive, floppy disk drive, tape drive, flash memory card, or memory stick. In addition, disk storage 1024 can include storage media separately or in combination with other storage media including, but not limited to, an optical disk drive such as a compact disk read only memory device, compact disk recordable drive, compact disk rewritable drive or a digital versatile disk read only memory. To facilitate connection of the disk storage devices 1024 to system bus 1018, a removable or non-removable interface is typically used, such as interface 1026.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, read only memory, programmable read only memory, electrically programmable read only memory, electrically erasable read only memory, flash memory or other memory technology, compact disk read only memory, digital versatile disk or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can include non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium. As such, for example, a computer-readable medium can comprise executable instructions stored thereon that, in response to execution, cause a system comprising a processor to perform operations, comprising: transmitting a request for data via an air interface or other wireless interface to a remote device, e.g., DMC 110, 210, 310, 410, etc., wherein the request is related to receiving data by the system, e.g., mobile device 350, 450, etc., via the wireless interface, and in response to the transmitting the request, receiving data by the system via the wireless interface from the remote device, wherein: the data was received by the remote device from another device, e.g., server component(s) 340, 440, etc., associated with storing the data before being received by the system, the receipt of the data by the remote device is associated with a lower latency and a higher throughput than a latency and a throughput, respectively, of the wireless interface between the system and the remote device, and the data is received by the system, as a result of a push of the data by the remote device, without an additional request by the system.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software includes an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. As an example, a user interface can allow entry of user preference information 224, etc., and can be embodied in a touch sensitive display panel, a mouse input GUI, a command line controlled interface, etc., allowing a user to interact with computer 1012. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 include, for example, a serial port, a parallel port, a game port, a universal serial bus, an infrared port, a Bluetooth port, an IP port, or a logical port associated with a wireless service, etc. Output device(s) 1040 use some of the same type of ports as input device(s) 1036.

Thus, for example, a universal serial busport can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 include, by way of illustration and not limitation, video and sound cards that provide means of connection between output device 1040 and system bus 1018. It should be noted that other devices and/or systems of devices provide both input and output capabilities such as remote computer(s) 1044. As an example, vehicle subsystems, such as headlights, brake lights, stereos, vehicle information sharing device, etc., can include an output adapter 1042 to enable use in accordance with the presently disclosed subject matter.

Computer 1012 can operate in a networked environment using logical connections to one or more remote computers, such as remote computer(s) 1044. Remote computer(s) 1044 can be a personal computer, a server, a router, a network PC, cloud storage, cloud service, a workstation, a microprocessor based appliance, a peer device, or other common network node and the like, and typically includes many or all of the elements described relative to computer 1012.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local area networks and wide area networks. Local area network technologies include fiber distributed data interface, copper distributed data interface, Ethernet, Token Ring and the like. Wide area network technologies include, but are not limited to, point-to-point links, circuit-switching networks like integrated services digital networks and variations thereon, packet switching networks, and digital subscriber lines. As noted below, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can include, for example, internal and external technologies such as modems, including regular telephone grade modems, cable modems and digital subscriber line modems, integrated services digital network adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Further, the term “include” is intended to be employed as an open or inclusive term, rather than a closed or exclusive term. The term “include” can be substituted with the term “comprising” and is to be treated with similar scope, unless otherwise explicitly used otherwise. As an example, “a basket of fruit including an apple” is to be treated with the same breadth of scope as, “a basket of fruit comprising an apple.”

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point,” “base station,” “Node B,” “evolved Node B,” “home Node B,” “home access point,” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can include packetized or frame-based flows.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. UEs do not normally connect directly to the core networks of a large service provider but can be routed to the core by way of a switch or radio access network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g. call transfer) or implicitly (e.g., call waiting). It is to be noted that service “execution” may or may not be a core network functionality as third party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include broadcast technologies (e.g., sub-Hertz, extremely low frequency, very low frequency, low frequency, medium frequency, high frequency, very high frequency, ultra-high frequency, super-high frequency, terahertz broadcasts, etc.); Ethernet; X.25; powerline-type networking, e.g., Powerline audio video Ethernet, etc.; femtocell technology; Wi-Fi; worldwide interoperability for microwave access; enhanced general packet radio service; third generation partnership project, long term evolution; third generation partnership project universal mobile telecommunications system; third generation partnership project 2, ultra mobile broadband; high speed packet access; high speed downlink packet access; high speed uplink packet access; enhanced data rates for global system for mobile communication evolution radio access network; universal mobile telecommunications system terrestrial radio access network; or long term evolution advanced.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system comprising:
a processor; and
a memory that stores executable instructions that, when executed by the processor, facilitate performance of operations, comprising:
transmitting a request for data via a wireless interface to a remote device located remote from the system, wherein the request is related to receiving data by the system via the wireless interface; and
in response to the transmitting the request, receiving data by the system via the wireless interface from the remote device, wherein:
the data was received by the remote device from another device associated with storing the data before being received by the system,
the receipt of the data by the remote device is associated with a lower latency and a higher throughput than a latency and a throughput, respectively, of the wireless interface between the system and the remote device, and
the data is received by the system, as a result of a push of the data by the remote device, without an additional request by the system.

2. The system of claim 1, wherein the data received by the system via the wireless interface is received within a determined time of the remote device receiving the data from the other device.

3. The system of claim 1, wherein the data received by the system, via the wireless interface, was bundled into a first batch by the remote device in response to a collection of the data by the remote device.

4. The system of claim 3, wherein the first batch comprises at least half of the data received by the remote device before being received by the system, via the wireless interface, as the result of the push of the data.

5. The system of claim 3, wherein the first batch comprises a less than half of the data received by the remote device before being received by the system, via the wireless interface, as the result of the push of the data.

6. The system of claim 5, wherein a second batch comprising another minority of the data is received by the system, via the wireless interface, subsequent to the first batch being received by the processor via the wireless interface.

7. The system of claim 3, wherein the first batch comprises up to a determined amount of data associated with a threshold batch size value.

8. A system, comprising:
a processor; and
a memory that stores executable instructions that, when executed by the processor, facilitate performance of operations, comprising:
receiving a request for data via a wireless interface from a user equipment located remote from the processor, wherein the request is related to pushing data to the user equipment via the wireless interface;
in response to receiving the request, pushing the data to the user equipment via the wireless interface, wherein:
the data is received, before being pushed to the user equipment, by the system from a device associated with storing the data,
the receipt of the data by the system is associated with a lower latency and a higher throughput than a latency and a throughput, respectively, of the wireless interface between the system and the user equipment, and
the data is pushed to the user equipment by the system without the system receiving an additional request from the user equipment;
in response to receipt of the data by the system, parsing the data received by the system to determine a dependency related to additional data;
receiving the additional data related to the dependency; and
pushing the additional data to the user equipment from the system via the wireless interface.

9. The system of claim 8, wherein the data pushed to the user equipment, by the system via the wireless interface, is pushed to the user equipment receiving the data substantially near in time to the data being received by the system from the device associated with storing the data.

10. The system of claim 8, wherein the data pushed to the user equipment, by the system via the wireless interface, was bundled into a first batch by the system in response to a collection of the data by the system.

11. The system of claim 10, wherein the first batch comprises a majority of the data received by the system before being pushed by the system, via the wireless interface, to the user equipment.

12. The system of claim 10, wherein the first batch comprises a minority of the data received by the system before being pushed by the system, via the wireless interface, to the user equipment.

13. The system of claim 12, wherein a second batch comprising another minority of the data is pushed by the system, via the wireless interface, to the user equipment subsequent to the first batch being pushed to the user equipment.

14. The system of claim 10, wherein the first batch comprises up to a defined amount of data designated by a value associated with determining a batch data volume limit.

15. A method, comprising:
receiving, by a device comprising a processor, a request for webpage data via an air interface from a user equipment located remote from the processor, wherein the request is related to transferring webpage data to the user equipment via the air interface; and
in response to receiving the request, sending, by the device, the webpage data to the user equipment via the air interface, wherein:
the webpage data is received by the device, from a server device associated with storing the webpage data, before being sent to the user equipment,
the receipt of the webpage data by the device is associated with a lower latency and a higher throughput than a latency and a throughput, respectively, of the air interface between the device and the user equipment, and
the webpage data is transferred to the user equipment by the device without the device receiving an additional request from the user equipment.

16. The method of claim 15, wherein the webpage data sent to the user equipment, by the device via the air interface, is sent concurrently with the device receiving the webpage data from the server device associated with storing the webpage data.

17. The method of claim 15, wherein the webpage data sent to the user equipment, by the device via the air interface, was bundled into a first batch comprising at least a portion of the webpage data in response to a collection of the webpage data by the device.

18. The method of claim 17, wherein the first batch comprises more than half of the webpage data received by the device before being sent by the device, via the air interface, to the user equipment.

19. The method of claim 17, wherein the first batch comprises less than half of the webpage data received by the device before being sent by the device, via the air interface, to the user equipment.

20. The method of claim 17, wherein the first batch comprises less than a defined amount of webpage data indicated by a threshold value related to an amount of data that a batch can comprise.
